(19) United States
(12) Patent Application Publication
(10) Pub. No.: US 2025/0193796 A1
(43) Pub. Date: Jun. 12, 2025

(54) METHOD AND APPARATUS FOR DETERMINING BANDWIDTH PART OF USER EQUIPMENT WITH WAKE-UP RECEIVER IN WIRELESS COMMUNICATION SYSTEM

(71) Applicant: Samsung Electronics Co., Ltd., Suwon-si (KR)

(72) Inventors: Seunghoon CHOI, Suwon-si (KR); Hyunsuk RYU, Suwon-si (KR); Hyewon YANG, Suwon-si (KR); Jaewon LEE, Suwon-si (KR); Junyung YI, Suwon-si (KR)

(21) Appl. No.: 18/970,206

(22) Filed: Dec. 5, 2024

(30) Foreign Application Priority Data
Dec. 8, 2023 (KR) 10-2023-0178058

(51) Int. Cl. H04W 52/02; H04W 52/14; H04W 56/00

(52) U.S. Cl. CPC H04W 52/0235; H04W 52/143; H04W 56/004

(57) ABSTRACT

A method performed by a user equipment (UE) in a wireless communication system is provided. The method includes transmitting, to a base station, capability information indicating that a wake-up receiver (WUR) is supported at the UE, receiving configuration information regarding a synchronization signal for the WUR or a wake-up signal (WUS) via master information block (MIB) or system information block (SIB), based on the capability information, identifying a bandwidth part (BWP) indicated by the configuration information, and receiving the synchronization signal for the WUR or the WUS on the identified BWP.

### CROSS-REFERENCE TO RELATED APPLICATION(S)

This application is based on and claims priority under 35 U.S.C. § 119(a) of a Korean patent application number 10-2023-0178058, filed on Dec. 8, 2023, in the Korean Intellectual Property Office, the disclosure of which is incorporated by reference herein in its entirety.

### BACKGROUND

### 1. Field

The disclosure relates to a method and apparatus for a user equipment (UE) with a wake-up receiver to determine a bandwidth part (BWP) for receiving a wake-up signal or turning on a main radio and then receiving data in a wireless communication system.

### 2. Description of Related Art

A 5^{th} generation (5G) mobile communication technology defines a broad frequency band to enable a high date rate and new services, and may be implemented not only in a ‘Sub 6 GHz’ band including 3.5 GHz but also in an ultra high frequency band (‘Above 6 GHz’) referred to as millimeter wave (mmWave) including 28 GHz, 39 GHz, and the like. Also, for a 6^{th} generation (6G) mobile communication technology referred to as a system beyond 5G communication (beyond 5G), in order to achieve a data rate fifty times faster than the 5G mobile communication technology and ultra-low latency one-tenth of the 5G mobile communication technology, implementation of the 6G mobile communication technology in the terahertz band (e.g., the 95 GHz to 3 THz band) is being considered.

In the early phase of the development of the 5G mobile communication technology, in order to support services and satisfy performance requirements of enhanced Mobile BroadBand (eMBB), Ultra Reliable Low Latency Communications (URLLC), and massive Machine-Type Communications (mMTC), there has been ongoing standardization about beamforming and massive multiple input multiple output (MIMO) for mitigating pathloss of radio waves and increasing transmission distances of radio wave in a mmWave band, supporting numerologies (for example, operation of multiple subcarrier spacings) for efficiently utilizing mmWave resources and dynamic operation of slot formats, initial access technologies for supporting multi-beam transmission and broadband, definition and operation of bandwidth part (BWP), new channel coding methods such as a low density parity check (LDPC) code for a large amount of data transmission and a polar code for highly reliable transmission of control information, L2 pre-processing, and network slicing for providing a dedicated network specialized to a specific service.

Currently, there are ongoing discussions about improvement and performance enhancement of initial 5G mobile communication technologies in consideration of services to be supported by the 5G mobile communication technology, and there has been physical layer standardization of technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) that is UE-satellite direct communication for providing coverage in an area in which communication with terrestrial networks is unavailable, and positioning.

Moreover, there has been ongoing standardization of air interface architecture/protocol regarding technologies such as industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel for simplifying random access procedures (2-step RACH for NR), and standardization of system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

When the 5G mobile communication system is commercialized, connected devices being on a rapidly increasing trend are being predicted to be connected to communication networks, and therefore, it is predicted that enhancement of functions and performance of the 5G mobile communication system and integrated operations of the connected devices are required. To this end, new researches are scheduled for eXtended Reality (XR) for efficiently supporting Augmented Reality (AR), Virtual Reality (VR), Mixed Reality (MR) and the like, 5G performance improvement and complexity reduction by utilizing artificial intelligence (AI) and machine learning (ML), AI service support, metaverse service support, drone communication, and the like.

Also, such development of the 5G mobile communication system will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of the 6G mobile communication technologies and improving system networks, AI-based communication technology for implementing system optimization by utilizing satellites and AI from a design stage and internalizing end-to-end AI support functions, and next-generation distributed computing technology for implementing services at levels of complexity exceeding the limit of UE operation capability by utilizing ultra-high-performance communication and computing resources.

According to development in a wireless communication system as described above, there is a demand for a signal transmission scheme for a UE with a wake-up receiver so as to solve an excessive power consumption problem of the UE and achieve high energy efficiency.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for decreasing power consumption and improving energy efficiency of a user equipment (UE) with a wake-up receiver.

Additional aspects will be set forth in part in the description which follows and, in part, will be apparent from the description, or may be learned by practice of the presented embodiments.

In accordance with an aspect of the disclosure, a method performed by a UE in a wireless communication system is provided. The method includes transmitting, to a base station, capability information indicating that a wake-up receiver (WUR) is supported at the UE, receiving configuration information regarding a synchronization signal for the WUR or a wake-up signal (WUS) via master information block (MIB) or system information block (SIB), based on the capability information, identifying a bandwidth part (BWP) indicated by the configuration information, and receiving the synchronization signal for the WUR or the WUS on the identified BWP.

In case that an antenna port is shared between the WUR and a main radio of the UE, the configuration information may indicate a common initial BWP, and in case that separate antenna ports are configured at the WUR and the main radio of the UE, the configuration information may indicate a dedicated BWP for the WUR.

In case that an antenna port is shared between the WUR and a main radio of the UE, the main radio may turn on after first switching delay time from a time at which the WUS is received, in case that separate antenna ports are configured at the WUR and the main radio of the UE, the main radio may turn on after second switching delay time from a time at which the WUS is received, and the second switching delay time is different from the first switching delay time.

The method may further include receiving a downlink signal on a common initial BWP via a main radio of the UE, after receiving the WUS.

The method may further include identifying a BWP indicated by the WUS, and receiving a downlink signal on the identified BWP via a main radio of the UE.

The method may further include receiving a downlink signal on a last activated BWP before receiving the WUS via a main radio of the UE.

The method may further include receiving information regarding one or more BWPs via a higher layer signaling, and receiving a downlink signal on a BWP with a pre-configured index, among the one or more BWPs, via a main radio of the UE.

In accordance with another aspect of the disclosure, a method performed by a base station (BS) in a wireless communication system is provided. The method includes receiving, from a UE, capability information indicating that a WUR is supported at the UE, transmitting configuration information regarding a synchronization signal for the WUR or a WUS via MIB or SIB, based on the capability information, and transmitting the synchronization signal for the WUR or the WUS on a BWP indicated by the configuration information.

In accordance with another aspect of the disclosure, a UE in a wireless communication system is provided. The UE includes at least one transceiver including a WUR and a main radio, and at least one processor coupled with the at least one transceiver and configured to transmit, to a base station, capability information indicating that the WUR is supported at the UE, receive configuration information regarding a synchronization signal for the WUR or a WUS via MIB or SIB, based on the capability information, identify a BWP indicated by the configuration information, and receive the synchronization signal for the WUR or the WUS on the identified BWP.

In accordance with another aspect of the disclosure, a BS in a wireless communication system is provided. The BS includes at least one transceiver, and at least one processor coupled with the transceiver and configured to receive, from a UE, capability information indicating that a WUR is supported at the UE, transmit configuration information regarding a synchronization signal for the WUR or a WUS via MIB or SIB, based on the capability information, and transmit the synchronization signal for the WUR or the WUS on a BWP indicated by the configuration information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain in a wireless communication system according to an embodiment of the disclosure;

FIG. 2 illustrates a time domain mapping structure and a beam sweeping operation for a synchronization signal according to an embodiment of the disclosure;

FIG. 3 illustrates a flow of signals for a random access (RA) according to an embodiment of the disclosure;

FIG. 4 illustrates a flow of signals for a user equipment (UE) to report UE capability information to a base station (BS) according to an embodiment of the disclosure;

FIG. 5 is a diagram illustrating an example of state switching of a BS and a UE, and a state of a UE according to a state of a BS according to an embodiment of the disclosure;

FIG. 6 is a flowchart showing a flow of operations in which a UE having a wake-up receiver (WUR) receives a WUR-dedicated synchronization signal and a wake-up signal (WUS), and receives a downlink (DL) signal, according to an embodiment of the disclosure;

FIG. 7 is a flowchart showing a flow of operations in which a BS transmits a WUR-dedicated synchronization signal and a WUS, and transmits a DL signal, according to an embodiment of the disclosure;

FIG. 8 is a block diagram of a UE, according to an embodiment of the disclosure; and

FIG. 9 is a block diagram of a BS, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

For the same reason, some elements in the drawings are exaggerated, omitted, or schematically illustrated. Also, size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein. Rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like components.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used in the present embodiment refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, according to an embodiment of the disclosure, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the elements and “ . . . units“may be combined into fewer elements and” . . . units” or further separated into additional elements and “ . . . units”. Further, the elements and “ . . . units” may be implemented to operate one or more central processing units (CPUs) in a device or a secure multimedia card. Also, in an embodiment of the disclosure, a “unit” may include one or more processors.

In the following descriptions of the disclosure, well-known functions or configurations are not described in detail because they would obscure the disclosure with unnecessary details. Hereinafter, embodiments of the disclosure will be described in detail with reference to accompanying drawings.

Hereinafter, terms identifying an access node, terms indicating network entities, terms indicating messages, terms indicating an interface between network entities, and terms indicating various pieces of identification information, as used in the following description, are exemplified for convenience of descriptions. Accordingly, the disclosure is not limited to terms to be described below, and other terms indicating objects having equal technical meanings may be used.

In the descriptions below, the terms “physical channel” and “signal” may be interchangeably used with “data” or “control signal.” For example, a physical downlink shared channel (PDSCH) is a term that indicates a physical channel on which data is transmitted, however, the PDSCH may also refer to data. That is, in the disclosure, the expression “transmit a physical channel” may have the same meaning as the expression “transmit data or a signal via a physical channel”.

Hereinafter, in the disclosure, higher layer signaling may refer to a method of transferring a signal to a user equipment (UE) from a base station on a downlink (DL) data channel of a physical layer or to the BS from the UE on an uplink (UL) data channel of the physical layer. The higher layer signaling may be understood as radio resource control (RRC) signaling or a media access control (MAC) control element (CE).

Also, in the disclosure, various embodiments will now be described by using terms and names defined in some communication standards (e.g., the third generation partnership project (3GPP)), but the disclosure is not limited to the terms and names. Various embodiments of the disclosure may be easily modified and applied to other communication systems. Also, the term “terminals (UEs)” may refer to not only mobile phones, smartphones, Internet of things (IoT) devices, and sensors but also other wireless communication devices.

Hereinafter, a base station is an entity that allocates resources to a UE, and may be at least one of a next-generation node B (gNode B/gNB), an evolved node B (eNode B/eNB), a Node B, a base station (BS), a radio access unit, a BS controller, or a node on a network. In the disclosure, a terminal may include a UE, a mobile station (MS), a cellular phone, a smartphone, a computer, or a multimedia system capable of performing a communication function. However, the disclosure is not limited to the above example. Although Long Term Evolution (LTE), LTE-Advanced (LTE-A), or New Radio (NR) systems are mentioned as examples in the following description, embodiments of the disclosure may also be applied to other communication systems having similar technical backgrounds or channel types. Furthermore, embodiments of the disclosure are applicable to other communication systems through modification at the discretion of one of ordinary skill in the art without greatly departing from the scope of the disclosure.

In order to satisfy exponentially increasing demand with respect wireless data traffic, initial standards of the 5th-generation (5G) system or the NR access technology which is a next-generation communication system after LTE or evolved universal terrestrial radio access (E-UTRA) and LTE-A or E-UTRA evolution are completed. Compared to the legacy mobile communication system focusing general voice/data communications, the 5G system aims to satisfy various services and requirements, such as enhanced Mobile BroadBand (eMBB) services for improving the existing voice/data communication, Ultra-Reliable and Low Latency Communication (URLLC) services, massive MTC (mMTC) services for supporting communication between a massive number of devices, etc.

Compared to the legacy LTE and LTE-A where a maximum system transmission bandwidth for a single carrier is limited to 20 MHz, the 5G system aims to provide a high-speed data service at several Gbps by using a very large ultra-wide bandwidth. Accordingly, for the 5G system, an ultra-high frequency band from several GHz up to 100 GHz, in which frequencies having ultrawide bandwidths are easily made available, is being considered as a candidate frequency. In addition, wide-bandwidth frequencies for the 5G system may be obtained by reassigning or allocating frequencies among frequency bands included in a range of several hundreds of MHz to several GHz used by the legacy mobile communication systems.

A radio wave in the ultra-high frequency band has a wavelength of several millimeters (mm) and is also referred to as a millimeter wave (mmWave). However, in the ultra-high frequency band, a pathloss of radio waves increases with an increase in frequency, and thus, a coverage range of a mobile communication system is reduced.

In order to overcome the reduction in coverage in the ultra-high frequency band, a beamforming technology is applied to increase a radio wave arrival distance by focusing a radiation energy of radio waves to a certain target point using a plurality of antennas. That is, a signal to which the beamforming technology is applied has a relatively narrow beam width, and radiation energy is concentrated within the narrow beam width, so that the radio wave arrival distance is increased. The beamforming technology may be applied at both a transmitter and a receiver. In addition to increasing the coverage range, the beamforming technology also has an effect of reducing interference in a region other than a beamforming direction. In order to appropriately implement the beamforming technology, an accurate transmit/receive beam measurement and feedback method is required. The beamforming technology may be applied to a control channel or a data channel having a one-to-one correspondence between a certain UE and a BS. Also, in order to increase coverage, the beamforming technology may be applied for control channels and data channels via which the BS transmits, to multiple UEs in a system, common signals such as a synchronization signal, a physical broadcast channel (PBCH), and system information. When the beamforming technology is applied to the common signals, a beam sweeping technique of transmitting a signal by changing a beam direction is additionally applied to allow the common signals to reach a UE located at any position within a cell.

As another requirement for the 5G systems, an ultra-low latency service with a transmission delay about 1 ms between a transmitter and a receiver is required. As a method for reducing the transmission delay, a frame structure based on a short transmission time interval (TTI) compared to that in LTE and LTE-A needs to be designed. A TTI is a basic time unit for performing scheduling, and a TTI in the legacy LTE and LTE-A systems corresponds to one subframe with a length of 1 ms. For example, as a short TTI for satisfying the requirement for the ultra-low latency service in the 5G systems, TTIs of 0.5 ms, 0.25 ms, 0.125 ms, etc. that are shorter than the TTI in the legacy LTE and LTE-A systems may be supported.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

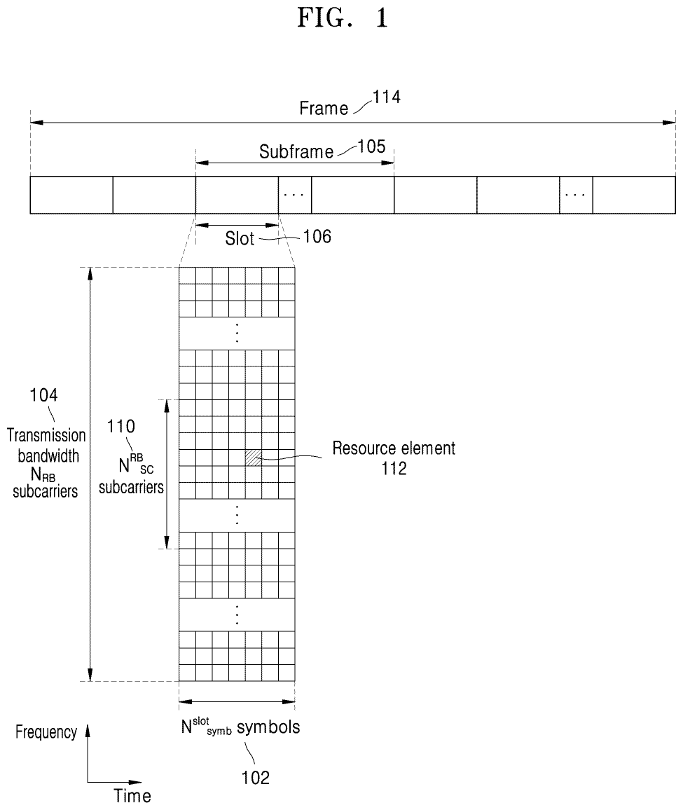

FIG. 1 is a diagram illustrating a basic structure of a time-frequency domain in a wireless communication system according to an embodiment of the disclosure.

Referring to FIG. 1, a basic structure of a time-frequency domain that is a radio resource region over which data or a control channel of a 5G communication system is transmitted will now be described.

Referring to FIG. 1, the horizontal axis represents a time domain and the vertical axis represents a frequency domain. A minimum transmission unit in the time domain of the wireless communication system is an Orthogonal Frequency Division Multiplexing (OFDM) symbol, and N_{symb}^{slot} symbols 102 may be gathered to constitute one slot 106, and Nₛₗₒₜ^{subframe} slots may be gathered to constitute one subframe 105. A length of the subframe 105 may be 1.0 ms, and 10 subframes may be gathered to constitute one frame 114 of 10 ms. A minimum transmission unit in the frequency domain is a subcarrier, and N_{BW} subcarriers 104 may be gathered to constitute a full system transmission bandwidth.

A basic unit of a resource in the time-frequency domain is a resource element (RE) 112 and may be defined as an OFDM symbol index and a subcarrier index. A resource block (RB) or a physical resource block (PRB) may be defined as N_{sc}^{RB} consecutive subcarriers 110 in the frequency domain. In the 5G system, N_{sc}^{RB}, and a data rate may increase in proportion to the number of RBs scheduled to a UE.

In the wireless communication system, a BS maps data in an RB unit, and in general, scheduling of RBs constituting one slot may be performed for a certain UE. That is, in the 5G system, a basic time unit for performing scheduling may be a slot, and a basic frequency unit for performing scheduling may be an RB.

N_{symb}^{slot} that is the number of OFDM symbols is determined according to a length of a cyclic prefix (CP) added to each symbol so as to prevent interference between symbols, and for example, when a normal CP is applied, N_{symb}^{slot}, and when an extended CP is applied, N_{symb}^{slot}. Because the extended CP is applied to a system having a relatively greater radio transmission distance than the normal CP, orthogonality between symbols may be maintained. In a case of the normal CP, a ratio of a CP length to a symbol length is maintained at a constant value, and thus, overhead due to the CP may be constantly maintained, regardless of subcarrier spacings. That is, when subcarrier spacing is small, a symbol length may increase, so that the CP length may also increase. On the contrary, when subcarrier spacing is large, the symbol length may decrease, so that the CP length may also decrease. The symbol length and the CP length may be inversely proportional to subcarrier spacing.

In the wireless communication system, various frame structures may be supported by adjusting subcarrier spacing so as to satisfy various services and requirements. For example, in terms of an operating frequency band, as the subcarrier spacing is greater, it is more advantageous to recover phase noise in a high frequency band. In terms of a transmission time, as the subcarrier spacing is greater, a symbol length of the time domain is shorter and thus a slot length is shorter, such that it is more advantageous to support an ultra-low latency service such as URLLC. In terms of a cell size, as the CP length is longer, it is possible to support a large cell, and thus, as the subcarrier spacing is smaller, it is possible to support a relatively large cell. A cell indicates an area covered by one BS in mobile communication.

The subcarrier spacing, the CP length, etc. are essential information for OFDM transmission and reception, and seamless transmission and reception may be performed only when the BS and the UE recognize the subcarrier spacing, the CP length, etc. as common values.

Table 1 shows a relation between subcarrier spacing configuration (μ), subcarrier spacing (Δf), and CP length.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 shows the number of symbols (N_{symb}^{slot}) per one slot, the number of slots (Nₛₗₒₜ^{frame,μ}) per one frame, and the number of slots (Nₛₗₒₜ^{subframe,μ}) per one subframe, for each subcarrier spacing (μ) in the case of the normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 shows the number of symbols (N_{symb}^{slot}) per one slot, the number of slots (Nₛₗₒₜ^{frame,μ}) per one frame, and the number of slots (Nₛₗₒₜ^{subframe,μ}) per one subframe, for each subcarrier spacing (μ) in the case of the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At the initial stage of introduction of the 5G system, at least coexistence or dual mode operation with the legacy LTE and/or LTE-A system (hereinafter, the LTE/LTE-A system) was expected. In this manner, the legacy LTE/LTE-A may provide a stable system operation to a UE, and the 5G system may provide improved services to the UE. Therefore, a frame structure of the 5G system may need to include at least the LTE/LTE-A frame structure or the essential parameter set (subcarrier spacing=15 kHz).

For example, comparing a frame structure where subcarrier spacing configuration μ=0 (hereinafter, frame structure A) with a frame structure where subcarrier spacing configuration μ=1 (hereinafter, frame structure B), subcarrier spacing and an RB size in frame structure B are increased twice and a slot length and a symbol length are reduced twice, compared with frame structure A. In frame structure B, 2 slots may constitute 1 subframe, and 20 subframes may constitute 1 frame.

When the frame structures of the 5G system are generalized, high expandability may be provided by making essential parameter sets such as the subcarrier spacing, the CP length, the slot length, etc. have an integer multiple relation for each frame structure. Also, a subframe having a fixed length of 1 ms may be defined to indicate a reference time unit irrelevant to the frame structure.

The frame structures may be applied to correspond to various scenarios. In terms of the cell size, as the CP length is longer, a larger cell may be supported, and thus, frame structure A may support relatively large cells, compared with frame structure B. In terms of the operating frequency band, as the subcarrier spacing is greater, it is more advantageous to recover phase noise in a high frequency band, and thus, frame structure B may support a relatively high operating frequency, compared with frame structure A. In terms of the service, as the slot length that is a basic time unit of scheduling is shorter, it is more advantageous to support an ultra-low latency service such as URLLC, and thus, frame structure B may be relatively appropriate for URLLC services compared with frame structure A.

Hereinafter, in the description of the disclosure, a UL may refer to a radio link for transmitting data or a control signal from a UE to a BS, and a DL may refer to a radio link for transmitting data or a control signal from the BS to the UE.

In an initial access operation in which a UE initially accesses a system, the UE may synchronize DL time and frequency from a synchronization signal transmitted from a BS and may obtain cell identifier (cell ID), via cell search. Then, the UE may receive a PBCH by using the obtained cell ID, and may obtain, from the PBCH, a master information block (MIB) that is essential system information. In addition, the UE may receive a system information block (SIB) transmitted from the BS, and thus, may obtain cell-common transmission and reception control information from the SIB. The cell-common transmission and reception control information may include random access-associated control information, paging-associated control information, common control information with respect to various physical channels.

A synchronization signal is a signal that is a reference of cell search, and subcarrier spacing may be applied to be adapted to a channel environment such as a phase noise, for each frequency band. In order for a data channel or a control channel to support various services described above, subcarrier spacing may be adaptively applied according to service types.

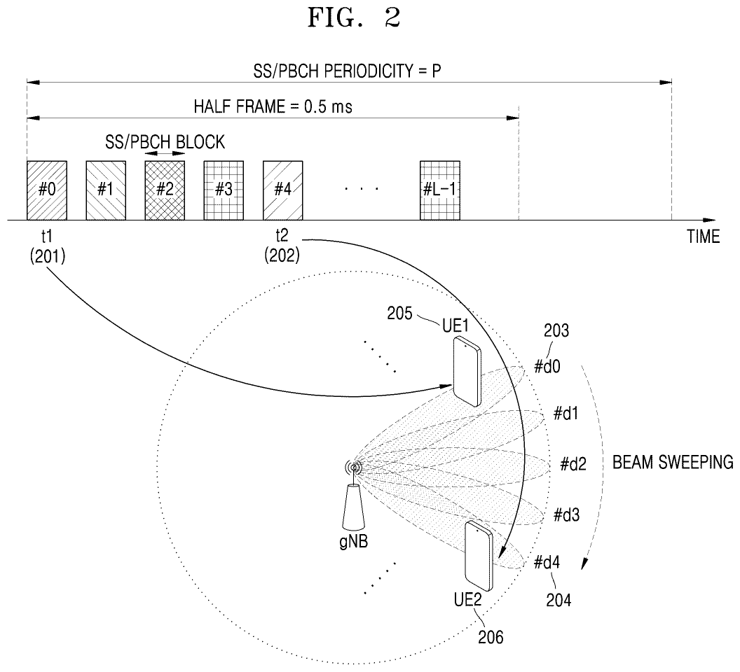

FIG. 2 illustrates a time domain mapping structure and a beam sweeping operation for a synchronization signal according to an embodiment of the disclosure.

Hereinafter, the following elements may be defined for description.
Primary synchronization signal (PSS): It is a signal used as a reference for DL time/frequency synchronization and may provide partial information of a cell ID.
Secondary synchronization signal (SSS): It is used as a reference for DL time/frequency synchronization and may provide other partial information of the cell ID. The SSS may also serve as a reference signal for demodulation of a PBCH.
Physical broadcast channel (PBCH): A PBCH may provide a MIB that is essential system information needed for the UE to transmit and receive a data channel and a control channel. The essential system information may include search space-associated control information indicating radio resource mapping information of a control channel, scheduling control information of a separate data channel for transmitting system information, information such as a system frame number (SFN) that is an index in a frame level that is timing reference.
SS/PBCH block (or SSB): The SS/PBCH block may consist of N OFDM symbols and may include a combination of the PSS, the SSS, and the PBCH. For a system using a beam sweeping technique, an SS/PBCH block may be the smallest unit for applying beam sweeping. In the 5G system, it may be that N=4. The BS may transmit a maximum of L SS/PBCH blocks, and the L SS/PBCH blocks are mapped within a half frame (0.5 ms). The L SS/PBCH blocks may be periodically repeated with a periodicity P. The BS may inform the UE of the periodicity P by signaling. If there is no separate signaling for the periodicity P, the UE applies a predetermined default value.

In further description of the MIB, the MIB may include information as in Table 4 below, and a PBCH payload and a PBCH demodulation reference signal (DMRS) include the following additional information. Further detailed description of the MIB in the 5G system may be referred to TS 38.331 specification.

TABLE 4

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

Synchronization signal block information: offset of a frequency domain of a synchronization signal block is indicated via 4 bits (ssb-SubcarrierOffset) in the MIB. An index of the synchronization signal block including the PBCH may be indirectly obtained by decoding the PBCH and PBCH DMRS. In more detail, in a frequency band of 6 GHz or less, 3 bits obtained by decoding the PBCH DRMS may indicate the index of the synchronization signal block, and in a frequency band of 6 GHz or more, 3 bits obtained by decoding the PBCH DMRS and 3 bits included in the PBCH payload and obtained by decoding the PBCH, that is, a total of 6 bits, may indicate the index of the synchronization signal block including the PBCH.
Physical downlink control channel (PDCCH) information: subcarrier spacing of a common downlink control channel may be indicated via 1 bit (subCarrierSpacingCommon) in the MIB, and time-frequency resource configuration information of a control resource set (CORESET) and a search space (SS) of ID 0 may be indicated via 8 bits (pdcch-ConfigSIB1). The CORESET of ID 0 may be referred to as controlResourceSetZero, and the SS of ID 0 may be referred to as searchspaceZero. In the disclosure, for convenience, the CORESET of ID 0 is referred to as CORESET #0 or control region #0, and the SS of ID 0 is referred to as SS #0. The UE may be configured, by the pdcch-ConfigSIB1, with a frequency resource indicating the number of RBs of CORESET #0 including a common search space set of a Type0-PDCCH CSS set and a time resource indicating the number of OFDM symbols, etc., during an initial access to a cell.
System frame number (SFN): 6 bits in the MIB is used to indicate a part of an SFN. 4 bits of least significant bits (LSB) of the SFN may be included in the PBCH payload, and the UE may indirectly obtain 4 bits of LSB of the SFN by decoding the PBCH.
Timing information in a radio frame: 1 bit (half frame) included in the index of the synchronization signal block and the PBCH payload and obtained by decoding the PBCH, and the UE may indirectly identify, based on that, whether the synchronization signal block is transmitted in a first or second half frame of the radio frame.

FIG. 2 illustrates an example in which beam sweeping is applied in a unit of an SS/PBCH block over time. In the example of FIG. 2, a first UE (UE1) 205 may receive an SS/PBCH block by using a beam emitted in direction #d0 203 due to beamforming applied to SS/PBCH block #0 at a time point t1 201. Also, a second UE (UE2) 206 may receive an SS/PBCH block by using a beam emitted in direction #d4 204 due to beamforming applied to SS/PBCH block #4 at a time point t2 202. The UE may obtain an optimal synchronization signal via a beam emitted from the BS in a direction toward a location of the UE. For example, it may be difficult for the UE1 205 to obtain time/frequency synchronization and essential system information from a SS/PBCH block via the beam emitted in the direction #d4 204 that is distant from the location of the UE1 205.

In addition to reception for the initial access procedure, the UE may receive an SS/PBCH block to determine whether a radio link quality of a current cell is maintained above a certain level. Also, in a handover procedure in which the UE moves from a current cell to a neighboring cell, the UE may receive an SS/PBCH block from the neighboring cell so as to determine a radio link quality of the neighboring cell and obtain time/frequency synchronization of the neighboring cell.

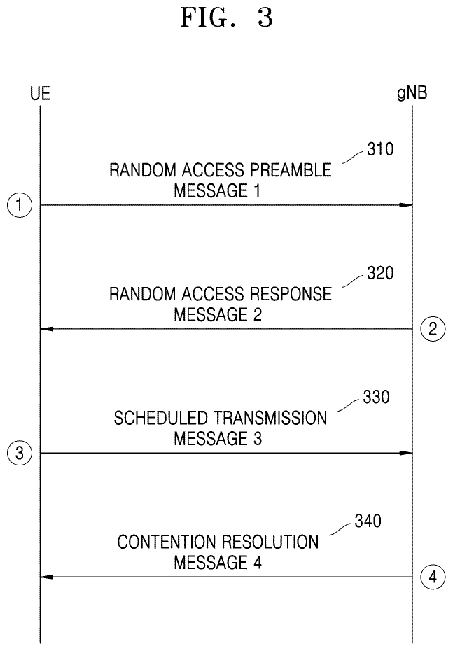

After the UE obtains MIB and system information from the BS via the initial access procedure, the UE may perform a random access procedure to switch a link with the BS to a connected state (or RRC_CONNECTED state). Upon completion of the random access procedure, the UE transitions to a connected state or an RRC_CONNECTED state, and one-to-one communication is enabled between the BS and the UE. Hereinafter, a random access procedure will be described in detail with reference to FIG. 3.

FIG. 3 illustrates a flow of signals for a random access (RA) according to an embodiment of the disclosure.

Referring to FIG. 3, in operation 310, a UE may transmit a random access preamble to a gNB (also referred to as the BS). In the random access procedure, the random access preamble, which is a first message transmitted by the UE, may be referred to as Message 1. The BS may measure a transmission delay value between the UE and the BS from the random access preamble and perform UL synchronization. In this case, the UE may randomly select a random access preamble to use from a set of random access preambles given by system information in advance. In addition, an initial transmission power for the random access preamble may be determined according to a pathloss between the BS and the UE, which is measured by the UE. Also, the UE may determine a direction of a transmit beam for the random access preamble, from a synchronization signal received from the BS, and may transmit the random access preamble in the determined direction of the transmit beam.

In operation 320, the BS may transmit a random access response (RAR) (or, message 2), in response to the random access preamble received in operation 310. The BS may transmit a UL transmission timing control command to the UE, based on the transmission delay value measured from the random access preamble. Also, the BS may transmit, to the UE, a UL resource to be used by the UE and a power control command as scheduling information. The scheduling information transmitted by the BS may include control information regarding a UL transmit beam of the UE.

If the UE does not successfully receive, from the BS, the RAR (or, Message 2) that is the scheduling information for Message 3 within a certain time period in operation 320, the UE may perform operation 310 again. If the UE performs operation 310 again, the UE may transmit the random access preamble with transmission power increased by a certain step (power ramping), thereby increasing the probability of reception of the random access preamble at the BS.

In operation 330, the UE may transmit UL data (Message 3) including its UE ID to the BS by using the UL resource allocated in operation 320. The UE may transmit the UL data including the UE ID to the BS via a UL data channel (e.g., a physical UL shared channel (PUSCH)). A transmission timing of the UL data channel for transmitting Message 3 may be controlled according to the timing control command received from the BS in operation 320. A transmission power for the UL data channel for transmitting Message 3 may be determined by considering the power control command received from the BS in operation 320 and a power ramping value applied to the random access preamble. The UL data channel for transmitting Message 3 may mean a first UL data signal transmitted by the UE to the BS after the UE transmits the random access preamble.

In operation 340, when the BS determines that the UE has performed the random access procedure without colliding with another UE, the BS may transmit data (Message 4) including the ID of the UE that has transmitted the UL data in operation 330 to the UE. When the UE receives the data transmitted by the BS in operation 340, the UE may determine that the random access procedure is successful. The UE may transmit, to the BS via a UL control channel (e.g., a physical UL control channel (PUCCH)), hybrid automatic repeat request acknowledgement (HARQ-ACK) information indicating whether Message 4 has been successfully received.

When the data transmitted by the UE in operation 330 collides with data transmitted by another UE and thus the BS fails to receive a data signal from the UE, the BS may no longer transmit data to the UE. When the UE fails to receive the data transmitted by the BS in operation 340 within a certain time period, the UE may determine that the random access procedure has failed and may restart the random access procedure from operation 310.

Upon successful completion of the random access procedure, the UE may transition to a connected state or RRC_CONNECTED state, and one-to-one communication between the BS and UE is enabled. The BS may receive UE capability information from the UE in the connected state or RRC_CONNECTED state, and may adjust scheduling based on the UE capability information of the corresponding UE. The UE may inform, via the UE capability information, the BS of whether the UE itself supports a certain function, a maximum allowable value of the function supported by the UE, etc. Accordingly, the UE capability information reported by each UE to the BS may have a different value for each UE.

For example, the UE may report, to the BS, UE capability information including at least one of the following control information as the UE capability information.
Control information associated with a frequency band supported by the UE
Control information associated with a channel bandwidth supported by the UE
Control information associated with a highest modulation scheme supported by the UE
Control information associated with a maximum number of beams supported by the UE
Control information associated with a maximum number of layers supported by the UE
Control information associated with channel state information (CSI) reporting supported by the UE
Control information about whether the UE supports frequency hopping
Control information associated with a bandwidth when carrier aggregation (CA) is supported
Control information about whether cross-carrier scheduling is supported when CA is supported

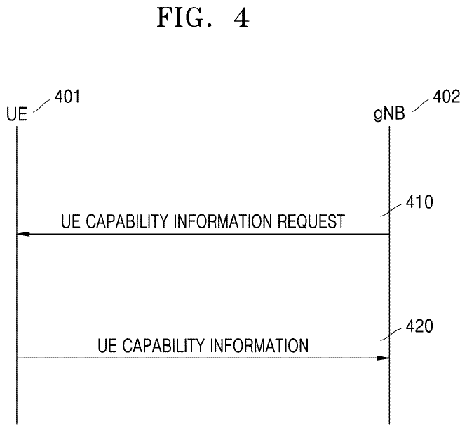

FIG. 4 illustrates a flow of signals for a UE to report UE capability information to a BS according to an embodiment of the disclosure.

Referring to FIG. 4, in operation 410, a gNB (also referred to as the BS) 402 may transmit a message of UE capability information request to a UE 401. In response to the UE capability information request from the BS 402, the UE 401 transmits UE capability information to the BS 402 in operation 420. According to an embodiment, regardless of the UE capability information request from the BS 402, the UE 401 may transmit UE capability information to the BS 402.

A UE connected to a BS, based on a UE capability information transceiving procedure, may perform one-to-one communication with the BS, as the UE in an RRC_CONNECTED state. On the other hand, a UE not connected to the BS is in an RRC_IDLE state, and the UE in the RRC_IDLE state may perform a procedure below.
To perform a UE-specific discontinuous reception (DRX) cycle configured by a higher layer
To receive a paging message from a core network
To obtain system information
Measurement operation associated with serving cell (or camped-on cell) and cell selection/reselection
Measurement operation associated with neighboring cell and cell reselection

In more detail with respect to the measurement operation associated with serving cell (or camped-on cell) and cell selection/reselection (in the disclosure, it is referred to as main radio (MR) radio resource management (RRM) measurement/evaluation), a UE may measure synchronization signal-reference signal received power (SS-RSRP) and synchronization signal-reference signal received quality (SS-RSRQ) levels for every M1*N1 DRX cycle with respect to a serving cell (or a camped-on cell), and may evaluate cell selection determination reference S, based on the measured values. Here, M1=2 in a case where an SSB-based measurement timing configuration (SMTC) cycle is greater than 20 ms, and a DRX cycle is equal to or less than 0.64 s, and M1=1 for other cases.

N1 may be determined based on Table 5 below.

TABLE 5

| | | | | Nₛₑᵣᵥ |
|---|---|---|---|---|
| | N1 | | | [number of |
| DRX cycle [s] | FR1 | FR2-1 | FR2-2 | DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination reference S may be satisfied when Sᵣₓₗₑᵥ>0 corresponding to SS-RSRP and S_{qual}>0 corresponding to SS-RSRQ.

$$\begin{matrix}{S}_{rxlev} = {Q}_{rxlevmeas} - ( {Q}_{rxlevmin} + {Q}_{rxlevminoffset} ) - {P}_{compensation} - {Q}_{offsettemp} \\ {S}_{qual} = {Q}_{qualmeas} - ( {Q}_{qualmin} + {Q}_{qualminoffset} ) - {Q}_{offsettemp}\end{matrix}$$

In this regard, Qᵣₓₗₑᵥₘₑₐₛ may be measured SS-RSRP, Q_{qualmeas} may be measured SS-RSRQ, and Qᵣₓₗₑᵥₘᵢₙ may be a magnitude level of a reception signal which is minimally required by a serving cell and may be received by the UE via system information, and Q_{qualmin} may be a quality level of the reception signal which is minimally required by the serving cell and may be received by the UE via the system information. Other parameters are provided in the 3GPP TS 38.304. In order to determine the measured SS-RSRP, the UE may determine the SS-RSRP of the serving cell by performing filtering on at least two measurement values apart by at least the half of a DRX cycle. In order to determine the measured SS-RSRQ, the UE may determine the SS-RSRQ of the serving cell by performing filtering on at least two measurement values apart by at least the half of the DRX cycle.

In more detail with respect to the measurement operation associated with neighboring cell and cell reselection, when the UE determines that the serving cell does not satisfy the cell selection determination reference S during Nₛₑᵣᵥ consecutive DRX cycles, the UE may start measurement of all neighboring cells except for the serving cell. If the UE does not find a new appropriate cell for 10 s, a cell reselection procedure for a selected public land mobile network (PLMN) may start.

After the UE starts measurement of the neighboring cells, the UE may measure SS-RSRP and SS-RSRQ levels for every Tₘₑₐₛᵤᵣₑ, and may evaluate whether the neighboring cells satisfy a cell reselection determination reference within every Tₑᵥₐₗᵤₐₜₑ. The UE may evaluate whether a newly-detected cell satisfies a cell reselection determination reference within every T_{detect}. In a case where a neighboring cell is better than the serving cell within T_{reselection}, according to the cell reselection determination reference, and at the same time, at least 1 second has passed after the UE camped on the current serving cell, the UE may reselect the neighboring cell as a new serving cell. In this regard, the parameters such as Tₘₑₐₛᵤᵣₑ, Tₑᵥₐₗᵤₐₜₑ, T_{reselection}, etc. may be determined from the rules according to a DRX cycle, or may be configured by a higher layer signal. In order to determine a measured SS-RSRP, the UE may determine an SS-RSRP of the neighboring cell by performing filtering on at least two measurement values apart by at least the half of Tₘₑₐₛᵤᵣₑ.

The cell reselection determination reference may determine cell selection priorities, based on Rₛ and Rₙ which are calculated by parameters below. For example, a cell ranking may be determined in order of high values among Rₛ and Rₙ.

$$\begin{matrix}{R}_{s} = {Q}_{meas , s} + {Q}_{hyst} - {Qoffset}_{temp} \\ {R}_{n} = {Q}_{meas , n} - Qoffset - {Qoffset}_{temp}\end{matrix}$$

Here, Q_{meas,s} and Q_{meas,n} may respectively indicate RSRP measurement values of a serving cell and neighboring cells, and Q_{hyst}, Qoffset, Qoffsetₜₑₘₚ may be configured by a higher layer signal.

In relation to neighboring cell measurement, when a specific condition is satisfied, the neighboring cell measurement may be stopped or may be performed with a period longer than the Tₘₑₐₛᵤᵣₑ. According to an embodiment of the disclosure, when the UE moves with a low speed or stops within a cell or determines that the UE is not present at a cell boundary, the UE may perform the neighboring cell measurement with a long period obtained by multiplying Tₘₑₐₛᵤᵣₑ by a scaling factor or may stop the neighboring cell measurement during maximally 1 hour.

A UE in a new state referred to as RRC_INACTIVE is defined so as to decrease an energy and time consumed in an initial access by the UE in the 5G system. The UE in RRC_INACTIVE may perform operations below, in addition to operations performed by a UE in RRC_IDLE.
To store access stratum (AS) information requested for cell access
To perform an operation of UE-specific DRX cycle configured by an RRC layer
To perform radio access network (RAN)-based notification area (RNA) configuration usable in handover by an RRC layer and periodic update
To monitor a RAN-based paging message transmitted via an inactive-radio network temporary identifier (I-RNTI)

A UE in an RRC_CONNECTED state may receive an RRC Release indication from the UE, and thus, may transition from the RRC_CONNECTED state to an RRC_INACTIVE or RRC_IDLE state.

A UE in an RRC_INACTIVE or RRC_IDLE state may perform a random access and complete all random access procedures, and thus, may transition from the RRC_INACTIVE or RRC_IDLE state to an RRC_CONNECTED state.

Next, BWP configuration in the 5G communication system will now be described in detail.

In the 5G communication system, a BS may configure a UE with one or more BWPs, and may configure, for each BWP, a plurality of pieces of information below.

TABLE 6

| | |
|---|---|
| BWP ::= | SEQUENCE { |
| bwp-ID | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |

}

In addition to the configuration information above, various parameters associated with a BWP may be configured for the UE. The plurality of pieces of information may be transmitted from the BS to the UE by higher layer signaling, e.g., RRC signaling. At least one BWP among the configured one or more BWPs may be activated. Whether to activate a configured BWP may be notified from the BS to the UE semi-statically by RRC signaling or dynamically by downlink control information (DCI). As another example, whether a BWP is activated may be transmitted via a MAC CE. In addition, at least two signaling among RRC signaling, a MAC CE, or DCI may be combined to transmit information about activation of a BWP.

Before the UE is RRC connected, the UE may be configured by the BS with an initial BWP for initial access in a MIB or SIB1.

In more detail about configuration of CORESET #0, SS #0, and the initial BWP, the UE may receive, via the MIB in an initial access process, configuration information for CORESET #0 and SS #0 in which a PDCCH may be transmitted for reception of system information (e.g., remaining system information (RMSI) or SIB1) requested for initial access. Each of the CORESET and the search space which are configured in the MIB may be regarded with identity (ID) 0. The BS may notify, in the MIB, the UE of configuration information such as frequency allocation information, time allocation information, numerology, etc., for CORESET #0. Also, the BS may notify, in the MIB, the UE of configuration information such as a monitoring periodicity and occasion for the CORESET #0, i.e., configuration information for SS #0.

In a method of configuring the initial BWP, UEs before being RRC connected may determine, via an MIB, configuration information for the initial BWP in an initial access process. In more detail, the UE may be configured, based on an MIB of a PBCH, with a CORESET for a DL control channel on which DCI for scheduling a SIB may be transmitted. A bandwidth of the CORESET configured based on the MIB may be regarded as the initial BWP, and the UE may receive, on the initial BWP, a PDSCH on which the SIB is transmitted. The initial BWP may also be used for other system information (OSI), paging, or random access, in addition to reception of the SIB. If the UE receives configuration information for the initial BWP via SIB1, the UE may determine the initial BWP, according to the received configuration information. CORESET #0, SS #0, and the initial BWP which are received via the MIB or the SIB1 may each be information to be commonly applied to all UEs in a cell, and thus, are referred to as common CORESET #0, common SS #0, and the common initial BWP, in the disclosure.

Hereinafter, a scheduling method by which a BS transmits DL data to a UE or indicates UL data transmission of the UE will now be described.

DCI may be control information transmitted by the BS to the UE via a DL link. DCI may include DL data scheduling information or UL data scheduling information for a certain UE. In general, the BS may independently channel-code DCI for each UE and then may transmit it to a corresponding UE via a PDCCH that is a physical control channel for DL.

The BS may apply and operate a predefined DCI format for a UE to be scheduled according to purposes such as whether DCI carries scheduling information for DL data (DL assignment), whether the DCI carries scheduling information for UL data (UL grant), whether the DCI is DCI for power control, etc.

The BS may transmit DL data to the UE via a PDSCH that is a physical channel for DL data transmission. The BS may inform the UE of scheduling information, such as a specific mapping location of the PDSCH in the time-frequency domain, a modulation scheme, HARQ-associated control information, power control information, etc., via DCI related to DL data scheduling information among DCIs transmitted on the PDCCH.

The UE may transmit UL data to the BS via a PUSCH that is a physical channel for UL data transmission. The BS may inform the UE of scheduling information, such as a specific mapping location of the PUSCH in the time-frequency domain, a modulation scheme, HARQ-associated control information, power control information, etc., via DCI related to UL data scheduling information among DCIs transmitted on the PDCCH.

Time-frequency resources on which a PDCCH is mapped may be referred to as a control resource set (CORESET). The CORESET may be configured in all or some frequency resources of a bandwidth supported by a UE in a frequency region. The CORESET may be configured with one or more OFDM symbols in the time region, and may be defined by a control resource set duration. A BS may configure the UE with one or more CORESETs by higher layer signaling (e.g., system information, MIB, or RRC signaling). When the CORESET is configured for the UE, it may mean that the BS provides the UE with information such as a CORESET ID, a frequency location of the CORESET, and a symbol length of the CORESET. A plurality of pieces of information provided from the BS to the UE so as to configure a CORESET may include at least some of information included in Table 7.

TABLE 7

| | |
|---|---|
| ControlResourceSet ::= | SEQUENCE { |
| controlResourceSetId | ControlResourceSetId , |
| frequencyDomainResources | BIT STRING (SIZE (45)), |
| duration | INTEGER (1..maxCoReSetDuration), |

(CORESET duration)

| | |
|---|---|
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks−1) |

```
OPTIONAL -- Need S
      (interleaver shift)
    },
```

| | |
|---|---|
| nonInterleaved | NULL |

},

| | |
|---|---|
| precoderGranularity | ENUMERATED {sameAsREG-bundle, allContiguousRBs}, |

(precoding unit)

| | |
|---|---|
| tci-StatesPDCCH-ToAddList | SEQUENCE(SIZE (1..maxNrofTCI-StatesPDCCH)) |

OF TCI-StateId OPTIONAL, -- Cond NotSIB1-initialBWP
(QCL configuration information)

| | |
|---|---|
| tci-StatesPDCCH-ToReleaseList | SEQUENCE(SIZE (1..maxNrofTCI-StatesPDCCH)) |

OF TCI-StateId OPTIONAL, -- Cond NotSIB1-initialBWP
(QCL configuration information)

| | |
|---|---|
| tci-PresentInDCI ENUMERATED {enabled} | OPTIONAL, -- Need |

S
(QCL indicator configuration information in DCI)

| | | |
|---|---|---|
| pdcch-DMRS-ScramblingID | INTEGER (0..65535) | OPTIONAL, |

-- Need S
(PDCCH DMRS Scrambling Identifier)
}

A CORESET may consist of N_{RB}^{CORESET} RBs in a frequency domain and may consist of N_{symb}^{CORESET}∈{1,2,3} symbols in a time domain. A NR PDCCH may consist of one or more control channel elements (CCEs). One CCE may include 6 resource element groups (REGs), and each REG may be defined as one RB during one OFDM symbol. REGs in one CORESET may be numbered in a time-first manner, starting with 0 for a first OFDM symbol and a lowest-numbered RB in the CORESET.

An interleaving method and a non-interleaving method may be supported as a method of transmitting a PDCCH. A BS may configure a UE as to whether to perform interleaving transmission or non-interleaving transmission for each CORESET by higher layer signaling. Interleaving may be performed in units of REG bundles. The term ‘REG bundle’ may be defined as a set of one or more REGs. The UE may determine a CCE-to-REG mapping method in the CORESET by using the following method as in Table 8 based on whether to perform interleaving or non-interleaving transmission configured from the BS.

```
TABLE 8
The CCE-to-REG mapping for a control-resource set can be interleaved or non-interleave
d and is described by REG bundles:
    - REG bundle i is defined as REGs {iL,iL + 1,...,iL + L−1} where L is the REG bundl
    e size, i = 0,1, ... ,N_{REG}^{CORESET}/L − 1, and N_{REG}^{CORESET} = N_{RB}^{CORESET}N_{symb}^{CORESET} is the number
      of REGs in the CORESET
    - CCE j consists of REG bundles {f(6j/L),f(6j/L + 1),...,f(6j/L + 6/L−1)} where
      f(·) is an interleaver
For non-interleaved CCE-to-REG mapping, L = 6 and f(x) = x.
For interleaved CCE-to-REG mapping, L ∈ {2,6}for N_{symb}^{CORESET} = 1 and L ∈ {N_{symb}^{CORESET},6} for
  N_{symb}^{CORESET} ∈ {2,3}. The interleaver is defined by
```

```
f(x) = (rC + c + n_{shift}) mod (N_{REG}^{CORESET}/L)
        x = cR + r
      r = 0,1, ... , R − 1
      c = 0,1, ... , C − 1
    C = N_{REG}^{CORESET}/(LR)
```

where R ∈{2,3,6,}.

The BS may inform, by signaling, the UE of information about a symbol to which a PDCCH is mapped within a slot, configuration information such as transmission periodicity, or the like.

A search space of the PDCCH will now be described. The number of CCEs required to transmit the PDCCH may be 1, 2, 4, 8, or 16 depending on an aggregation level (AL), and different numbers of CCEs may be used to implement link adaptation of the DL control channel. For example, when AL=L, one DL control channel may be transmitted in L CCEs. The UE performs blind decoding to detect a signal without knowing information about the DL control channel, and thus, a search space representing a set of CCEs may be defined for the blind decoding. The search space may be defined as a set of DL control channel candidates that include CCEs on which the UE needs to attempt decoding at a given AL, and because there are various ALs each making a bundle with 1, 2, 4, 8, or 16 CCEs, the UE may have a plurality of search spaces. A search space set may be defined as a set of search spaces at all the configured ALs.

The search spaces may be classified into a common search space (CSS) and a UE-specific search space (USS). A certain group of UEs or all the UEs may monitor a common search space of the PDCCH so as to receive dynamic scheduling of the system information or receive cell-common control information such as a paging message. For example, the UE may monitor a CSS of the PDCCH so as to receive PDSCH scheduling allocation information for receiving system information. Because a certain group of UEs or all the UEs need to receive the PDCCH, the common search space may be defined as a set of predefined CCEs. The UE may receive UE-specific PDSCH or PUSCH scheduling allocation information by monitoring a USS of the PDCCH. The USS may be UE-specifically defined as a function of various system parameters and an ID of the UE.

A BS may configure the UE with configuration information about a search space of a PDCCH by higher layer signaling (e.g., SIB, MIB, or RRC signaling). For example, the BS may configure the UE with the number of PDCCH candidates at each L, monitoring periodicity for the search space, monitoring occasion on symbols in the slot for the search space, a type of the search space (CSS or USS), a combination of a DCI format to be monitored in the search space and a radio network temporary identifier (RNTI), a CORESET index to monitor the search space, or the like. For example, a parameter with respect to the search space of the PDCCH may include a plurality of pieces of information as in Table 9 below.

TABLE 9

| | |
|---|---|
| SearchSpace ::= | SEQUENCE { |
| searchSpaceId | SearchSpaceId, |

| | |
|---|---|
| controlResourceSetId | OPTIONAL, -- Cond SetupOnly |

(CORESET Id)

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

| | |
|---|---|
| } | OPTIONAL, -- Cond |

Setup

| | | |
|---|---|---|
| duration | INTEGER (2..2559) | OPTIONAL, |

-- Need R
(monitoring duration)

| | |
|---|---|
| monitoringSymbolsWithinSlot | BIT STRING (SIZE (14)) |

OPTIONAL, -- Cond Setup
(monitoring symbol location in slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond |

Setup

| | |
|---|---|
| searchSpaceType | CHOICE { |
| common | SEQUENCE { |

(common search space)

| | |
|---|---|
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

```
OPTIONAL -- Need R
        },
        ...
```

| | |
|---|---|
| } | OPTIONAL, -- Need R |

| | |
|---|---|
| dci-Format2-1 | SEQUENCE { |

...

| | |
|---|---|
| } | OPTIONAL, -- Need R |

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |
| dummy1 | ENUMERATED {sl1, sl2, sl4, sl5, sl8, sl10, sl16, |

s120} OPTIONAL, -- Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |

(UE-specific search space)

| | |
|---|---|
| dci-Formats | ENUMERATED {formats0-0-And-1-0, formats0-1- |

```
And-1-1},
      ...,
        }
```

| | |
|---|---|
| } | OPTIONAL -- Cond |

Setup2
}

Based on the configuration information transmitted to the UE, the BS may configure the UE with one or more search space sets. According to an embodiment of the disclosure, the BS may configure search space set 1 and search space set 2 for the UE. The BS may configure the UE to monitor DCI format A scrambled by an X-RNTI in the search space set 1 in the CSS and to monitor DCI format B scrambled by a Y-RNTI in the search space set 2 in the USS.

Based on configuration information transmitted from the BS, one or more search space sets may be present in the CSS or the USS. For example, search space set #1 and search space set #2 may be configured as the CSS, and search space set #3 and search space set #4 may be configured as the USS.

According to various embodiments of the disclosure, the UE may monitor combinations of DCI formats and RNTIs below. Obviously, the combinations are not limited to an example below, and are not limited to examples of combinations
DCI format 0_0/1_0 with CRC scrambled by cell RNTI (C-RNTI), configured scheduling RNTI (CS-RNTI), semi-persistent CSI-RNTI (SP-CSI-RNTI), random access RNTI (RA-RNTI), temporary Cell RNTI (TC-RNTI), paging RNTI (P-RNTI), system information RNTI (SI-RNTI)
DCI format 2_0 with CRC scrambled by slot format indicator RNTI (SFI-RNTI)
DCI format 2_1 with CRC scrambled by interruption RNTI (INT-RNTI)
DCI format 2_2 with CRC scrambled by transmit power control for PUSCH RNTI (TPC-PUSCH-RNTI), transmit power control for PUCCH RNTI (TPC-PUCCH-RNTI)
DCI format 2_3 with CRC scrambled by transmit power control for SRS RNTI (TPC-SRS-RNTI)

According to various embodiments of the disclosure, in the USS, the UE may monitor combinations of DCI formats and RNTIs below. However, this is merely an example, and the combinations of DCI formats and RNTIs that the UE monitors are not limited to examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may conform to definitions and purposes below. However, the definitions and the purposes of the RNTIs are not limited to the examples below, and according to embodiments of the disclosure, various definitions and purposes of the RNTIs may exist.
cell RNTI (C-RNTI): for UE-specific PDSCH or PUSCH scheduling
temporary Cell RNTI (TC-RNTI): for UE-specific PDSCH scheduling
configured scheduling RNTI (CS-RNTI): for semi-statically configured UE-specific PDSCH scheduling
random access RNTI (RA-RNTI): for PDSCH scheduling in a random access process
paging RNTI (P-RNTI): for scheduling a PDSCH on which paging is transmitted
system information RNTI (SI-RNTI): for scheduling a PDSCH on which system information is transmitted
interruption RNTI (INT-RNTI): for indicating whether to puncture the PDSCH
transmit power control for PUSCH RNTI (TPC-PUSCH-RNTI): for indicating power control command for a PUSCH
transmit power control for PUCCH RNTI (TPC-PUCCH-RNTI): for indicating power control command for a PUCCH
transmit power control for SRS RNTI (TPC-SRS-RNTI): for indicating power control command for an SRS

The DCI formats described above may conform to definitions as in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

A search space at aggregation level L with CORESET p and search space set s may be represented as in Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad Equation 1$$

L: aggregation level
nCI: carrier index
NCCE,p: total number of CCEs existing in control resource set
n_{s,f}^{μ}: slot index
M_{p,s,max}^{(L)}: number of PDCCH candidates of aggregation level L
m_{s,n}_{_{Cl}}=0, . . . , M(L)p,s,max−1: PDCCH candidates indices of aggregation level L
i=0, . . . , L−1

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 ,$$

$${A}_{0} = 39827 , {A}_{1} = 39829 , {A}_{2} = 39839 , D = 65537$$

nRNTI: UE identifier
A value Y_{p,n}_{_{s,f}}_{^{μ}} may correspond to 0 for CSS.

The value Y_{p,n}_{_{s,f}}_{^{μ}} may correspond to a value that may be initialized with UE ID (C-RNTI or ID configured for UE by BS) and that may change according to a time index for the USS.

As described above, in order to achieve an ultra high speed service with several Gbps in the 5G system, signal transmission and reception in an ultra-wide bandwidth of several tens to several hundreds of MHz or several GHz. The signal transmission and reception in the ultra-wide bandwidth may be supported via a signal component carrier or a carrier aggregation (CA) technology of combining several component carriers. When a mobile communication provider is not able to ensure, over a signal component carrier, a frequency with a bandwidth enough to provide an ultra high speed data service, the CA technology may enable the ultra high speed data service by increasing a total sum of a frequency bandwidth by combining component carriers with relatively small bandwidth sizes.

The 5G system is designed and developed for various use cases. Energy efficiency of a UE is very important in the 5G system, as well as latency, reliability, and availability. A 5G UE has to charge weekly or daily, according to a user's use time, and generally consumes several tens of mW in RRC_IDLE/RRC_INACTIVE state, and several hundreds of mW in an RRC_CONNECTED state. A design to increase a battery lifetime may be an essential factor not only for improving a user experience but also for increasing energy efficiency. The energy efficiency may be more important for a terminal without a continuous energy source (e.g., terminal that uses a small chargeable and single coin cell battery). In 5G use cases, a sensor and an actuator are broadly arranged for monitoring, measurement, charging, etc., and in general, their batteries are not rechargeable and may be requested to last for at least few years. Also, a wearable device may include a smartwatch, a ring, an eHealth-related device, a medical monitoring device, etc., and in general, it is difficult for the wearable device to last for maximally 1 or 2 weeks, according to a usage time.

According to an embodiment of the disclosure, power consumption of a 5G terminal depends on set duration of wakeup periods (e.g., a paging cycle), and an extended discontinuous reception (eDRX) cycle with a large value may be used to satisfy a battery lifetime condition. However, as a battery lifetime lasts long, based on high latency, in the eDRX scheme, the eDRX scheme is not appropriate for a service with low latency. For example, in a use case of fire detection and extinguishment, fire shutters may need to be closed and sprinklers may need to be turned on by an actuator within one or two seconds from a time when fire is detected by a sensor. In this case, latency may be important, and thus, a long eDRX cycle is not appropriate because it cannot satisfy a latency condition.

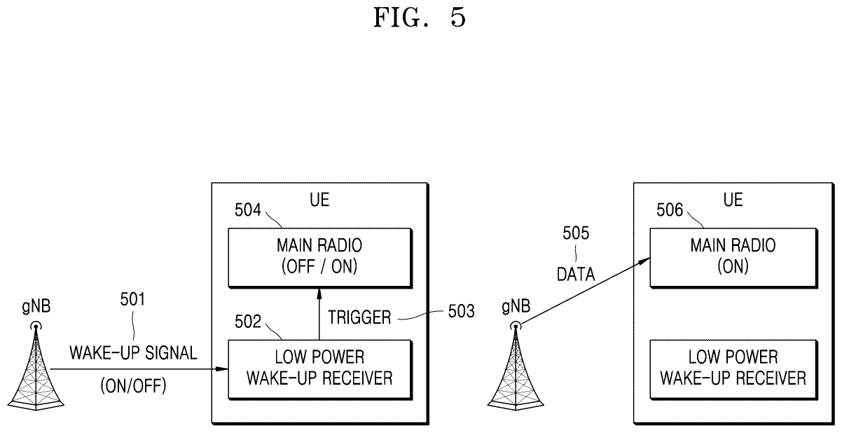

FIG. 5 is a diagram illustrating an example of state switching of a BS and a UE, and a state of a UE according to a state of a BS according to an embodiment of the disclosure. In detail, FIG. 5 illustrates state switching of a BS and a UE, for solving the aforementioned problems.

According to an embodiment of the disclosure, a 5G UE may need a periodic wakeup once per an eDRX cycle, and this may dominate power consumption of a period in which signaling or data traffic does not occur. If the UE can wake up only when the UE is triggered, as paging, power consumption may be significantly reduced. The significant power consumption may be achieved in a manner that a main radio (e.g., an existing NR radio) is triggered by using a wake-up signal (WUS) as shown in FIG. 5, and the main radio is turned on by using a wake-up receiver (WUR) only when data transceiving is requested, the WUR being a separate receiver for monitoring a WUS with ultra-low power.

According to an embodiment of the disclosure, in operation 501, a BS may transmit a WUS corresponding to ON or OFF to a UE.

In operation 502, the UE may receive the WUS by using a WUR.

In operation 503, the UE may trigger a main radio in an OFF or ON state based on information indicating that the received signal corresponds to ON or OFF.

In operation 504, the UE may wake up the main radio or set a state in which power is turned off. According to an embodiment of the disclosure, the UE may set a state of deep sleep (DS) or ultra deep sleep (UDS), rather than complete OFF.

In operation 505, when the BS has data traffic to be transmitted to the UE, and thus, the WUS transmitted from the BS in operation 501 is a signal corresponding to ON, in operation 506, the main radio may be ON, and the UE may receive data transmitted from the BS via the main radio, not the WUR.

According to an embodiment of the disclosure, as power consumption for monitoring a WUS depends on a design of a WUS, and a hardware module of a WUR used in signal detecting and processing, a gain may be maximized for IoT use cases (industrial sensors and controllers) and small form factor devices including wearable devices which are sensitive to power.

According to an embodiment of the disclosure, a UE including a WUR may report to a BS that the UE is capable of waking up a main radio by using the WUR or may report to the BS capability information indicating that the UE includes the WUR.

According to an embodiment of the disclosure, the UE may report to the BS capability information about a WUR via a UE capability information report procedure of FIG. 4.

According to an embodiment of the disclosure, the UE may report to the BS the capability information about the WUR via at least one step among a random access preamble or a UL data channel in the random access procedure of FIG. 3. According to an embodiment of the disclosure, random access preamble sets the UE including the WUR can transmit may be transmitted to the UE via system information. The UE may select a random access preamble from the sets the UE receives, and may transmit the random access preamble in operation 310 of the random access procedure of FIG. 3, based on the selected random access preamble. According to an embodiment of the disclosure, after the UE reports the capability information about the WUR to the BS, the UE may receive information indicating whether to use the WUR, from the BS, by at least one of higher layer signaling or a physical signal.

According to an embodiment of the disclosure, when the BS supports the UE including the WUR (e.g., when the BS has hardware capable of transmitting a WUS), the BS may receive the capability information about the WUR from the UE and then may determine whether to use the WUR. According to an embodiment of the disclosure, the BS may transmit, to the UE, a signal indicating whether to use the WUR or configuration information for reception of a WUS. According to an embodiment of the disclosure, the BS may transmit, to the UE, at least one of WUS reception by the UE or indication information for activating the WUR or indication information indicating WUS transmission by the BS. After a BS-configured (or defined in the rules) slot from a slot in which the signal is received, the UE may turn off the main radio or may turn on the WUR for monitoring a WUS. According to an embodiment of the disclosure, the UE may transmit, to the BS, at least one of a feedback indicating that a signal indicating whether to use the WUR has been received, before the UE turns off the main radio, or a feedback indicating that the WUR has been turned on, after the UE turns off the main radio.

According to an embodiment of the disclosure, when the BS does not support the UE including the WUR, the BS may receive the capability information about the WUR from the UE and then may transmit, to the UE, a signal indicating that the use of the WUR is not available. The UE may transmit, to the BS, a feedback indicating that the signal indicating that the use of the WUR is not available is received. According to an embodiment of the disclosure, the UE may perform an operation due to parameters of an existing power saving method configured by the BS using the existing power saving method (C-DRX or I-DRX such as paging).

According to various embodiments of the disclosure, after a procedure for capability report by the UE including the WUR and a check as to whether the WUR is supported (or allowed) by the BS, the WUR of the UE may receive a WUS, and thus, may perform an operation of turning on or off a main radio of the UE. According to an embodiment of the disclosure, it is obvious that the UE may separately perform the operation of turning on or off the main radio, the operation of reporting a capability of the UE inducing the WUR, or an operation as to check whether the WUR is supported by the BS. For example, even when the operation of reporting the capability of the UE and the allowance procedure are not performed, the BS may transmit, to the UE, a signal indicating whether the WUR is to be used or indicating configuration information for reception of a WUS. Accordingly, the UE including the WUR from among UEs receiving a signal from the BS may perform ON/OFF of the main radio via the WUR.

According to an embodiment of the disclosure, after the operation of reporting the capability of the UE and the BS allowance procedure are performed, an operation of performing ON/OFF of a main radio via a WUR may be applied to all UEs (e.g., an RRC_CONNECTED UE, an RRC_IDLE/RRC_INACTIVE UE, or a UE accessing a cell (e.g., RRC_CONNECTED UE)) within the cell supported by the BS. When the operation of reporting the capability of the UE and the BS allowance procedure are not performed, an operation of performing ON/OFF of a main radio via a WUR may be applied to an RRC_IDLE/RRC_INACTIVE UE that camps on the cell supported by the BS. Also, various embodiments of the disclosure may include all or some of various operations to be disclosed below, or at least one of combinations of the operations by the UE including the WUR and the BS.

Hereinafter, according to embodiments of the disclosure, an operation in which the UE including the WUR turns on or off a main radio will now be described. Embodiments of the disclosure may include all or some of various operations to be disclosed below, or at least one of combinations of the operations by the UE including the WUR and the BS.

According to an embodiment of the disclosure, when a main radio of the UE is ON, the UE may receive a DL signal (or data) from the BS via the main radio. According to various embodiments of the disclosure, that a main radio is ‘ON’ may be expressed, but is not limited to, as the main radio is ‘turned on’ or the main radio is ‘activated’, etc., or may be expressed as similar or subsequently equal meaning. According to an embodiment of the disclosure, that the main radio is activated may mean that specific components (e.g., radio frequency (RF) or baseband (BB)) of the main radio are turned on or activated, or may be defined in the rules (e.g., the 3GPP TS document). However, according to various embodiments of the disclosure, it is not limited to what is described above, and that the main radio is activated may include similar or subsequently equal parameters or an operation being performed due to the parameters.

Alternatively, it may include that the main radio performs an operation of receiving a specific channel or a signal (e.g., SS/PBCH block including a synchronization signal or PDCCH including a DL control channel) which is defined in the 3GPP TS document.

According to an embodiment of the disclosure, when the main radio of the UE is OFF, the UE may be in a sleep period or may not receive a DL signal (or data) from the BS. According to various embodiments of the disclosure, that a main radio is ‘OFF’ may be expressed, but is not limited to, as the main radio is ‘turned off’ or the main radio is ‘inactivated’, etc., or may be expressed as similar or subsequently equal meaning. According to an embodiment of the disclosure, that the main radio is inactivated may mean that specific components (e.g., RF or BB) of the main radio are turned off or inactivated, or may be defined in the rules (e.g., the 3GPP TS document). However, according to various embodiments of the disclosure, it is not limited to what is described above, and that the main radio is inactivated may include similar or subsequently equal parameters or an operation being performed due to the parameters. Alternatively, it may include that the main radio no longer performs an operation of receiving a specific channel or a signal (e.g., SS/PBCH block including a synchronization signal or PDCCH including a DL control channel) which is defined in the 3GPP TS document.

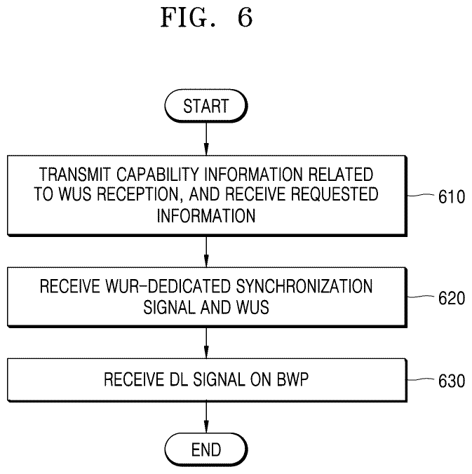

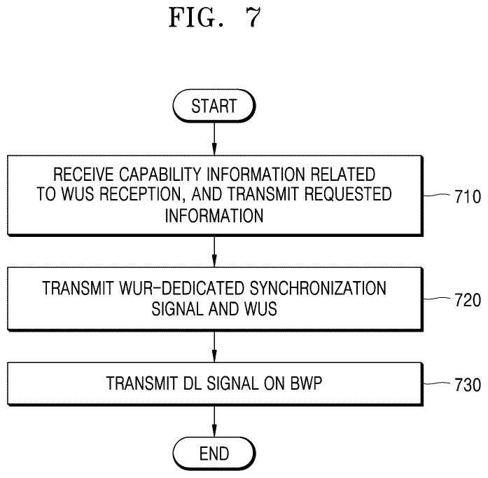

As described above, for power saving, only when the UE receives a WUS from the BS, the UE may trigger a main radio to ON via the WUR and may receive a DL signal from the BS via the main radio, and may turn off the main radio when the WUS is not received. In this case, the UE may receive a WUS or a synchronization signal for the WUR via a specific BWP X. Also, the UE may receive a DL control channel and a DL data channel via a specific BWP Y. In the disclosure, a method by which the UE determines the BWP so as to receive the signals will now be described. Also, necessary UE and BS procedures will now be described with reference to FIGS. 6 and 7.

In descriptions of embodiments below, it may be understood that operations or procedures which are expressed to be performed by a main radio or a WUR with respect to a UE including the WUR (i.e., the UE having capability of receiving a WUS) are performed by the UE (i.e., the UE having capability of receiving a WUS) including the WUR.

[Method by which UE Having WUR Determines BWP for Receiving WUS or WUR-Dedicated Synchronization Signal]

A scheme by which a UE having a WUR determines a BWP for receiving a WUS or a WUR-dedicated synchronization signal will now be described.

As a first scheme, the UE having the WUR may receive the WUS or the WUR-dedicated synchronization signal in a common CORESET #0 or a common initial BWP configured via MIB or SIB1. Configuration information for the WUS or the WUR-dedicated synchronization signal may be received by the UE having the WUR via MIB or SIB1. For example, SIB1 may include, at its end, lp-wus-Config that is configuration information for the WUS or lp-ss-Config that is configuration information for the WUR-dedicated synchronization signal, as below.

TABLE 11

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |
| ... | LP-WUS-Config, |

lp-wus-Config

| | |
|---|---|
| lp-ss-Config | LP-SS-Config, |

}

The first scheme may also be applied to a case in which a main radio of the UE having the WUR and the WUR share RF or Radio Frequency-Front End (RF-FE) or a physical antenna or an antenna port defined in the rules. For example, the first scheme may be applied to a case in which the main radio of the UE having the WUR and the WUR have UE capability of sharing RF or RF-FE or a physical antenna or an antenna port in the rules, or have reported the UE capability to the BS. However, this is merely an example, and it is not limited that the first scheme is applied only to the aforementioned case.

As a second scheme, the UE having the WUR may receive the WUS or the WUR-dedicated synchronization signal on a separate resource other than a common CORESET #0 or a common initial BWP configured for the UE having the WUR.

For example, new SIB for the UE having the WUR may include lp-wus-Config that is configuration information for the WUS or lp-ss-Config that is configuration information for the WUR-dedicated synchronization signal as below.

TABLE 12

| | |
|---|---|
| SIBForLP-WUS ::= | SEQUENCE { |
| lp-wus-Config | LP-WUS-Config, |
| lp-ss-Config | LP-SS-Config, |

}

The lp-wus-Config or the lp-ss-Config may include information indicating a frequency location and a frequency domain of the WUS or the WUR-dedicated synchronization signal, information indicating a time location, a time domain, and a period, information indicating subcarrier spacing, and information indicating cyclic prefix.

As another example, the UE having the WUR may receive configuration information for a dedicated-BWP for receiving the WUS or the WUR-dedicated synchronization signal via SIB1 or new SIB. For example, the configuration information for the dedicated-BWP for receiving the WUS or the WUR-dedicated synchronization signal may be included in the SIB1 as below.

TABLE 13

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |

...

| | |
|---|---|
| DownlinkBWP-LP-WUS-r19 | BWP-DownlinkCommon, |

}

As another example, the configuration information for the dedicated-BWP for receiving the WUS or the WUR-dedicated synchronization signal may be included in the new SIB as below.

TABLE 14

| | |
|---|---|
| SIBForLP-WUS ::= | SEQUENCE { |
| DownlinkBWP-LP-WUS-r19 | BWP-DownlinkCommon, |

}

The DownlinkBWP-LP-WUS-r19 may include information indicating a frequency location and a frequency domain of the WUS or the WUR-dedicated synchronization signal, information indicating a time location, a time domain, and a period, information indicating subcarrier spacing, and information indicating cyclic prefix.

As a third scheme, the first or second scheme may be applied according to whether the main radio of the UE having the WUR and the WUR share RF or RF-FE or a physical antenna or an antenna port in the rules, or separately have or separately define RF or RF-FE or a physical antenna or an antenna port in the rules. For example, the first scheme may be applied to a case in which the main radio of the UE having the WUR and the WUR share RF or RF-FE or a physical antenna or an antenna port in the rules, and the second scheme may be applied to a case in which the main radio of the UE having the WUR and the WUR separately have or separately define RF or RF-FE or a physical antenna or an antenna port in the rules.

As a fourth scheme, other switching delay time may be applied from a time at which the WUR receives a WUS to time at which ON of the main radio is triggered, based on whether the main radio of the UE having the WUR and the WUR share, separately have, or separately define RF or RF-FE or a physical antenna or an antenna port in the rules. For example, after the UE receives the WUS, the UE may receive a DL signal from the BS after K symbols or K slots or K [us or ms], and in this regard, according to whether the main radio of the UE having the WUR and the WUR share, separately have, or separately define RF or RF-FE or a physical antenna or an antenna port in the rules, different values for K may be defined in the rules or the UE may report a different value for K to the BS. Alternatively, according to UE capability or BS configuration based on whether the WUS or the WUR-dedicated synchronization signal may be received in the common CORESET #0 or the common initial BWP or the WUS or the WUR-dedicated synchronization signal may be received on a separate resource, different values may be defined in the rules or the UE may report a different value to the BS.

In another embodiment, when the UE having the WUR receives configuration information for a dedicated BWP for reception of the WUS or the WUR-dedicated synchronization signal via SIB1 or new SIB, the number of available BWPs configurable by a higher layer signal may be decreased, compared to an existing UE that is a UE not having the WUR. For example, in a case of BWP #0 configuration option 1 (that is, option in which BWP #0 that is a common initial BWP is configured by BWP-DownlinkCommon and BWP-UplinkCommon of ServingCellConfigCommon which is a cell common higher layer signal from the BS, and is not configured by BWP-DownlinkDedicated or BWP-UplinkDedicated of ServingCellConfig which is a UE-dedicated higher layer signal), up to 4 BWP configurations are available for the existing UE, but, up to 3 BWP configurations are available for the UE having the WUR. As another example, in a case of BWP #0 configuration option 2 (that is, option in which BWP #0 that is a common initial BWP is configured by BWP-DownlinkCommon and BWP-UplinkCommon of ServingCellConfigCommon which is a cell common higher layer signal from the BS, and is configured by BWP-DownlinkDedicated or BWP-UplinkDedicated of ServingCellConfig which is a UE-dedicated higher layer signal), up to 3 BWP configurations are available for the existing UE, but, up to 2 BWP configurations are available for the UE having the WUR.

[Method by which UE Having WUR Receives WUS, Triggers ON of Main Radio, and then Determines BWP for Receiving DL Signal of Main Radio]

A scheme by which a UE having a WUR receives a WUS, triggers ON of a main radio, and then determines a BWP for receiving a DL signal of the main radio will now be described. The present embodiment may be applicable, regardless of whether a state of the UE is RRC_CONNECTED, RRC_IDLE, or RRC_INACTIVE.

As a first scheme, the UE having the WUR may receive the DL signal in a common initial BWP. This scheme has a merit in which the UE having the WUR determines the common initial BWP as a BWP for receiving a DL signal, and thus, a power saving effect can be achieved, but also has a demerit in which, as the common initial BWP is generally limited up to 20 MHz for CORESET #0, this may affect a transport resource for paging or system information which is transmitted all UEs in a cell.

As a second scheme, the UE having the WUR may receive the DL signal in a BWP indicated by the WUS. According to this scheme, the UE may assume that one or more BWPs have been already configured by a higher layer signal from the BS. The WUS may include information about an index of a BWP on which the DL signal has to be received. For example, the index of the BWP may indicate an identifier of the BWP. Accordingly, the UE having the WUR may determine, by receiving the WUS, the index of the BWP on which the DL signal has to be received, and may receive the DL signal on the BWP having the index. With this scheme, when a resource in a particular BWP is not sufficient due to signals transmission and reception by another UE, a BWP with a sufficient resource for DL signal reception is indicated for the UE having the WUR to perform DL signal reception.

As a third scheme, the UE having the WUR may receive a DL signal on a last activated BWP before the WUS is received. For example, as a BWP is determined as a default BWP when a BWP inactivity timer expires, the BWP inactivity timer may not run but may stop while WUS monitoring by the WUR is activated and thus the WUR monitors a WUS or while a main radio is off, and the BWP inactivity timer may operate only when the main radio is turned on based on the WUS being received. As another example, when the BWP inactivity timer operates, a DL signal may be received on a most-recently activated BWP, and when the BWP inactivity timer expires, a DL signal may be received on a default BWP.

As a fourth scheme, the UE having the WUR may receive a DL signal on a BWP having a specific index predefined in the rules from among BWPs configured by a higher layer signal. For example, the specific index may be a smallest index value from among indices of the configured BWPs.

As a fifth scheme, the UE having the WUR may receive a DL signal on a default BWP. With this scheme, even when the BWP inactivity timer does not expire, in a case where the main radio is turned on after the WUS is received, the DL signal may be received on the default BWP. A band size, an index, etc. of the default BWP may be configured by a higher layer signal, and when they are not configured by the higher layer signal, a BWP having a specific index value in the rules may be determined.

The embodiments described above may be combined with each other and used. Also, in each embodiment, that a value is configured in the rules may mean that a value is pre-configured in a UE or is configured by using at least one of RRC signaling, a MAC CE, or DCI. Two or more signaling among the aforementioned signaling may be combined to set a value, for example, candidates of values may be configured by RRC signaling, and one of the candidate values may be identified via the MAC CE or the DCI.

Hereinafter, according to various embodiments of the disclosure, a procedure for waking up a main radio in a sleep state will now be described. According to an embodiment of the disclosure, an operation of waking up the main radio may be combined with various operations according to various embodiments of the disclosure and performed or may be separately performed, and may not be an essential element.

According to various embodiments of the disclosure, when a BS has a channel or a signal to be transmitted to a UE, the BS may transmit a WUS to the UE. The UE or a WUR may receive the WUS, thereby turning on the main radio. According to an embodiment of the disclosure, an operation of receiving the WUS may be an indication to wake up the main radio. According to an embodiment of the disclosure, the WUS may include K information bits, and information indicating to wake up the main radio may be mapped to the K information bits. For example, an information bit included in the WUS is information of 1 bit, ‘1’ may indicate ON, and ‘0’ may indicate OFF. According to an embodiment of the disclosure, when there are a plurality of UEs or UE groups which receive a WUS, bits of the K information bits may respectively correspond to the plurality of UEs or the UE groups.

According to an embodiment of the disclosure, in view of transmission by the BS, when to transmit the WUS before transmission of a channel or a signal may be predefined. In view of reception by the UE, when it is available to receive the WUS before reception of a channel or a signal may also be predefined.

According to an embodiment of the disclosure, the UE may transmit, to the BS, information about time offset requested between transmission of the WUS and transmission of channel/signal, and the BS may configure the UE with the time offset between transmission of the WUS and transmission of the channel/signal, based on the received information. According to an embodiment of the disclosure, the UE may transmit the information about the time offset requested between transmission of the WUS and transmission of the channel/signal, to the BS, via a UE capability information report procedure or via a random access preamble or a UL data channel in a random access procedure. However, the disclosure is not limited thereto, and the UE may transmit the information about the time offset to the BS by a higher layer signal or various signals. The BS may configure the UE with the information about the time offset requested between transmission of the WUS and transmission of the channel/signal via a DL data channel of a random access response (e.g., message 2) or a random access contention resolution (e.g., message 4) in the random access procedure. However, the disclosure is not limited thereto, and the BS may configure the UE with the information about the time offset by a higher layer signal or various signals.

According to various embodiments of the disclosure, when the BS has a periodic channel or a periodic signal to be transmitted to the UE, the BS does not transmit a WUS whenever the BS has a channel or a signal to be transmitted, but instead, the UE or the WUR may turn on a main radio, according to a period based on configuration information of the periodic channel or the periodic signal which is configured by the BS.

According to an embodiment of the disclosure, the BS may transmit a WUS only in first transmission of the periodic channel or the periodic signal, and may omit transmission of the WUS in repeated channel or signal transmission thereafter. In this regard, the UE or the WUR may turn on the main radio, according to the period based on the configuration information of the periodic channel or the periodic signal which is configured by the BS.

According to an embodiment of the disclosure, a type of the periodic channel or the periodic signal which is transmitted/received by the BS and the UE may be predefined. According to an embodiment of the disclosure, a type of the periodic channel or the periodic signal may be configured by the BS. The BS may configure the UE with a type of the periodic channel or the periodic signal via the DL data channel of the random access response (e.g., message 2) or the random access contention resolution (e.g., message 4), or may configure the UE by a higher layer signal or another higher layer signal which indicates configuration information for WUS reception.

According to various embodiments of the disclosure, when the UE has a channel or a signal (e.g., a physical random access channel (PRACH) or a scheduling request (SR) or a buffer status report (BSR) to be transmitted to the BS or performs L1/L3-based measurement, the UE or the WUR may turn on the main radio, regardless of a WUS transmitted from the BS.

According to an embodiment of the disclosure, an operation in which the WUR receives a WUS with respect to UL transmission or L1/L3-based measurement from the UE to the BS, and turns on or off the main radio of the UE may not be applied.

According to an embodiment of the disclosure, regardless of an operation of receiving a WUS, a UL channel or a type of a UL signal or L1/L3-based measurement to be transmitted from the UE may be predefined. According to an embodiment of the disclosure, a UL channel or a type of a UL signal or L1/L3-based measurement may be configured by the BS. The BS may configure the UE with the UL channel or the type of the UL signal or the L1/L3-based measurement via the DL data channel of the random access response (e.g., message 2) or the random access contention resolution (e.g., message 4), or may configure the UE by a higher layer signal or another higher layer signal which indicates configuration information for WUS reception.

In another example, when a 2-step random access procedure defined in the 3GPP TS document is used, the BS may configure the UE with the information about the time offset or the configuration information of WUS reception, which is described in the aforementioned embodiments, via message B.

Hereinafter, according to various embodiments of the disclosure, an operation of turning off a main radio in an on state will now be described. According to an embodiment of the disclosure, when the main radio is in the on state, the operation of turning off the main radio may be combined with various operations according to various embodiments of the disclosure and performed or may be separately performed, and may not be an essential element.

According to various embodiments of the disclosure, when a BS does not have a channel or a signal to be transmitted to a UE, the BS may transmit a sleep signal to the UE. The UE or a WUR may receive the sleep signal, thereby turning off the main radio. According to an embodiment of the disclosure, an operation of receiving the sleep signal may be an indication to turning off the main radio. According to an embodiment of the disclosure, the sleep signal may be configured as a sequence separate from a WUS. According to an embodiment of the disclosure, the sleep signal may include information to which information indicating to turning off the main radio is mapped from among K information bits included in the WUS. For example, when the sleep signal is information of 1 bit, ‘0’ may indicate OFF, and ‘1’ may indicate ON.

According to various embodiments of the disclosure, the main radio of the UE may be turned off when a configured condition is satisfied. According to an embodiment of the disclosure, the condition configured for the main radio may correspond to a case in which the main radio fails to detect or decode a DL control channel, a specific channel, or a specific signal during a configured period. According to an embodiment of the disclosure, the BS may configure the UE with a plurality of pieces of configuration information (e.g., information including a period and a specific channel or signal) used for the UE to determine OFF of the main radio, by a higher layer signal or another higher layer signal which indicates configuration information for WUS reception.

According to various embodiments of the disclosure, the main radio of the UE may be always turned off after a channel or a signal is received. According to an embodiment of the disclosure, after the WUR receives a WUS from the BS and then the main radio is turned on to receive a channel or a signal, the main radio may be turned off. According to an embodiment of the disclosure, a time requested for the main radio to be turned off after reception of the channel or the signal is completed may be predefined. According to an embodiment of the disclosure, the UE may transmit, to the BS, information about the time requested for the main radio to be turned off, and the BS may configure the UE with the requested time, based on the received information. According to an embodiment of the disclosure, the information about the requested time, which is transmitted by the UE, may be transmitted to the BS via the UE capability information report procedure. According to an embodiment of the disclosure, the information about the requested time, which is transmitted by the UE, may be transmitted to the BS via a random access preamble or a UL data channel. However, the disclosure is not limited thereto, and the UE may transmit the information about the requested time to the BS by a higher layer signal. The BS may configure the UE with the information about the requested time, which is transmitted to the UE, via a DL data channel of a random access response (e.g., message 2) or a random access contention resolution (e.g., message 4). However, the disclosure is not limited thereto, and as described above in the various embodiments, the BS may configure the UE with the information about the requested time by a higher layer signal or may configure the UE with another message.

Hereinafter, according to various embodiments of the disclosure, when the UE or the main radio of the UE is in an RRC_CONNECTED state, the UE may be configured with connected mode DRX (C-DRX), and thus, the main radio may wake up and perform PDCCH reception at every DRX cycle. According to an embodiment of the disclosure, when the UE or the main radio of the UE is in the RRC_CONNECTED state, the UE (or the main radio) may be configured to receive a signal indicating whether to receive a PDCCH in a next DRX cycle.

According to an embodiment of the disclosure, when the main radio is in an RRC_IDLE/RRC_INACTIVE state, the UE may be configured with idle mode DRX (I-DRX), and thus, the main radio may wake up and receive a paging PDCCH at every paging cycle. According to an embodiment of the disclosure, when the UE or the main radio of the UE is in the RRC_CONNECTED state, the UE (or the main radio) may be configured to receive a signal indicating whether to receive a paging PDCCH in a next paging cycle.

Hereinafter, according to various embodiments of the disclosure, provided is an embodiment about a procedure by a UE operating as a WUR, when an ON/OFF indication operation based on WUS reception by the WUR and the main radio and an operation based on configuration of C-DRX or I-DRX coexist. According to an embodiment of the disclosure, an operation of the UE or the main radio of the UE which is related to RRC CONNECTED/IDLE/INACTIVE state may be combined with various operations according to various embodiments of the disclosure and performed or may be separately performed, and may not be an essential element.

According to various embodiments of the disclosure, when the UE having the WUR performs an operation of receiving a WUS and then turning on or off the main radio of the UE, the UE may not perform configuration of C-DRX or I-DRX and an operation according to the configuration. In this case, instead of performing the configuration of C-DRX or I-DRX and the operation according to the configuration, the UE may turn on the main radio of the UE only when a WUS indicating to wake up the main radio is received, and may receive a PDCCH and a PDSCH which are defined or configured to be received in C-DRX or I-DRX.

According to an embodiment of the disclosure, when the UE or the main radio of the UE is in the RRC_CONNECTED state, and an operation to be performed by the WUR is configured or activated by the BS, the UE may turn on the main radio when the UE receives a WUS indicating to wake up the main radio, and may perform a C-DRX_related operation (e.g., the main radio receives a PDCCH within drx_onDurationTimer at every DRX cycle) configured by the BS. According to an embodiment of the disclosure, the UE (or the main radio) may not perform an operation configured for the UE to receive a signal (e.g., DCI format 2_6) indicating whether to receive a PDCCH in a next DRX cycle. According to an embodiment of the disclosure, when the UE or the main radio of the UE is in the RRC_IDLE/INACTIVE state, and an operation to be performed by the WUR is configured or activated by the BS, the UE may turn on the main radio when the UE receives a WUS indicating to wake up the main radio, and may perform an I-DRX_related operation (e.g., the main radio wakes up and receives a paging PDCCH at every paging cycle) configured by the BS. According to an embodiment of the disclosure, the UE (or the main radio) may not perform an operation configured for the UE to receive a signal (e.g., DCI format 2_7) indicating whether to receive a paging PDCCH in a next paging cycle.

According to an embodiment of the disclosure, instead of an operation according to the configuration related to C-DRX or I-DRX, the UE may perform an operation of turning on the main radio and an operation of turning off the main radio according to the WUR and a WUS according to various embodiments of the disclosure. If an operation performed by the WUR is inactivated by the BS, the operations related to C-DRX or I-DRX which are configured by the BS may be performed again.

According to various embodiments of the disclosure, when an operation performed by the WUR of the UE is configured or activated by the BS, and the UE or the WUR receives a WUS and thus the main radio is turned on, the UE may transition to an RRC_CONNECTED state or may transition to an RRC_IDLE state or an RRC_INACTIVE state. According to an embodiment of the disclosure, to which state the UE transitions may be predetermined or may be determined by a higher layer signal or a separate higher layer signal with respect to configuration of an operation of the WUR by the BS.

According to an embodiment of the disclosure, in an example of a case in which information about transition of the UE is predetermined, a state of the main radio may follow a state in which the main radio was most recently turned on and nearly off immediately before a current on time. According to an embodiment of the disclosure, in another example of a case in which information about transition of the UE is predetermined, a state of the main radio may not be affected by configuration of an operation of the WUR and whether to activate the operation. For example, the state of the main radio of the UE may be determined only by a higher layer signal indicating at least one of RRC_CONNECTED, RRC_IDLE, or RRC_INACTIVE, and the UE may determine that the state of the main radio is not changed based on the configuration of the operation of the WUR and whether to activate the operation.

According to an embodiment of the disclosure, the WUS may include K information bits, and information about at least one of whether the main radio switches to an RRC_CONNECTED state, an RRC_IDLE state, or an RRC_INACTIVE state may be mapped to the K information bits.

According to an embodiment of the disclosure, when the UE or the main radio of the UE is RRC_CONNECTED, based on the determined state of the UE, it may be configured by the BS that the main radio may wake up at every DRX cycle due to C-DRX configured by the BS and may receive a PDCCH, or the UE (or the main radio) receives a signal indicating whether to receive a PDCCH in a next DRX cycle. According to an embodiment of the disclosure, when an operation for turning off the main radio according to various embodiments of the disclosure is performed while the UE receives the PDCCH (e.g., a PDCCH reception period), the UE may priorly perform a procedure for turning off the main radio.

According to an embodiment of the disclosure, when the UE or the main radio of the UE is RRC_IDLE/INACTIVE, the main radio may wake up and receive a paging PDCCH at every paging cycle due to I-DRX configured by the BS. The UE (or the main radio) may be configured by the BS so as to receive a signal indicating whether to receive a paging PDCCH in a next paging cycle. When an operation for turning off the main radio according to various embodiments of the disclosure is performed while the UE receives the paging PDCCH (e.g., a paging PDCCH reception period), the UE may priorly perform a procedure for turning off the main radio.

According to various embodiments of the disclosure, it is obvious that the aforementioned various operations of the UE (or the main radio) may be performed regardless of order, and an entity to perform the operations may be the UE or the main radio.

FIG. 6 is a flowchart showing a flow of operations in which a UE having a WUR receives a WUR-dedicated synchronization signal and a WUS, and receives a DL signal, according to an embodiment of the disclosure.

In operation 610, the UE may transmit capability information related to WUS reception to a BS, and may receive information requested for WUS reception from the BS. According to an embodiment of the disclosure, the UE having the WUR may report, to the BS, that the UE has capability of waking up a main radio by using the WUR, or may report, to the BS, capability information indicating that the UE has the WUR. According to an embodiment of the disclosure, the BS may transmit, to the UE, a signal indicating configuration information as to whether the WUR is used or WUS reception.

In operation 620, the UE may receive a WUS or a WUR-dedicated synchronization signal via the WUR. According to an embodiment of the disclosure, the UE having the WUR may receive, by a higher layer signal, information about a resource or a BWP on which the WUS or the WUR-dedicated synchronization signal is to be received, and may receive the WUS or the WUR-dedicated synchronization signal on the resource according to the information.

In operation 630, the UE may wake up the main radio by receiving the WUS, and may receive a DL signal on a BWP according to an embodiment of the disclosure.

Each operation described with reference to FIG. 6 may be performed according to UE operation described in at least one of the aforementioned embodiments of the disclosure.

FIG. 7 is a flowchart showing a flow of operations in which a BS transmits a WUR-dedicated synchronization signal and a WUS, and transmits a DL signal, according to an embodiment of the disclosure.

In operation 710, the BS may receive capability information related to WUS reception from a UE, and may transmit information requested for WUS reception to the UE. According to an embodiment of the disclosure, the UE having a WUR may report, to the BS, that the UE has capability of waking up a main radio by using the WUR, or may report, to the BS, capability information indicating that the UE has the WUR. According to an embodiment of the disclosure, the BS may transmit, to the UE, a signal indicating configuration information as to whether the WUR is used or WUS reception.

In operation 720, the BS may transmit a WUS or a WUR-dedicated synchronization signal for the UE having the WUR to receive via the WUR. According to an embodiment of the disclosure, the BS may transmit information about a resource or a BWP on which the WUS or the WUR-dedicated synchronization signal is to be received, to the UE having the WUR, by a higher layer signal, and may transmit the WUS or the WUR-dedicated synchronization signal on the resource according to the information.

In operation 730, the BS may transmit the WUS to the UE having the WUR, and may transmit a DL signal on a BWP according to an embodiment of the disclosure.

Each operation described with reference to FIG. 7 may be performed according to BS operation described in at least one of the aforementioned embodiments of the disclosure.

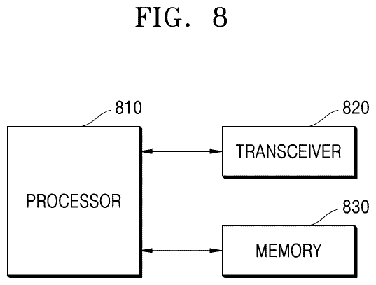

FIG. 8 is a block diagram of a UE, according to an embodiment of the disclosure.

Referring to FIG. 8, the UE of the disclosure may include a processor 810, a transceiver 820, and memory 830. However, elements of the UE are not limited to the example above. For example, the UE may include more elements than the aforementioned elements or may include fewer elements than the aforementioned elements. In addition, the processor 810, the transceiver 820, and the memory 830 may be implemented as one chip.

According to some embodiments of the disclosure, the processor 810 may control a series of processes in which the UE may operate according to the embodiment of the disclosure. For example, according to an embodiment of the disclosure, the processor 810 may control elements of the UE to perform at least one of a method of determining a BWP for the UE with a WUR or a signal transmitting and receiving method for the method. The processor 810 may be provided in plural, and may be configured to execute a program stored in the memory 830 to perform a communication control method by considering a power state of the UE of the disclosure.

The transceiver 820 may transmit and receive signals to and from a BS. The transmitted or received signals may include control information and data. The transceiver 820 may include a radio frequency (RF) transmitter for up-converting and amplifying a frequency of signals to be transmitted, and an RF receiver for low-noise-amplifying and down-converting a frequency of received signals. However, this is merely an example of the transceiver 820, and thus, elements of the transceiver 820 are not limited to the RF transmitter and the RF receiver. Also, the transceiver 820 may receive signals via wireless channels and output the signals to the processor 810, and may transmit signals output from the processor 810, via wireless channels.

According to some embodiment of the disclosure, the memory 830 may store programs and data necessary for operations of the UE. Also, the memory 830 may store control information or data which are included in a signal obtained by the UE. The memory 830 may be implemented as a storage medium including a read only memory (ROM), a random access memory (RAM), a hard disk, a compact disc (CD)-ROM, a digital versatile disc (DVD), or the like, or any combination thereof. Also, the UE may include a plurality of memories. According to some embodiment of the disclosure, the memory 830 may store the program for performing at least one of a method of determining a BWP for the UE with a WUR or a signal transmitting and receiving method for the method according to the embodiment of the disclosure.

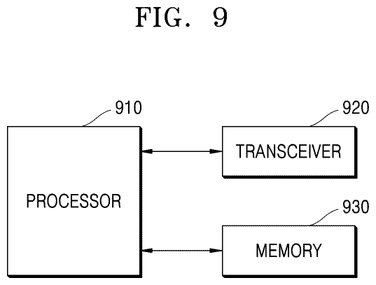

FIG. 9 is a block diagram of a BS, according to an embodiment of the disclosure.

Referring to FIG. 9, the BS of the disclosure may include a processor 910, a transceiver 920, and memory 930. However, elements of the BS are not limited to the example above. For example, the BS may include more elements than the aforementioned elements or may include fewer elements than the aforementioned elements. In addition, the processor 910, the transceiver 920, and the memory 930 may be implemented as one chip.

The processor 910 may control a series of processes in which the BS may operate according to the embodiment of the disclosure. For example, according to an embodiment of the disclosure, the processor 910 may control elements of the BS to perform at least one of a method of determining a BWP for a UE with a WUR or a signal transmitting and receiving method for the method.

The transceiver 920 may transmit and receive signals to and from a UE. The transmitted or received signals may include control information and data. The transceiver 920 may include a RF transmitter for up-converting and amplifying a frequency of signals to be transmitted, and an RF receiver for low-noise-amplifying and down-converting a frequency of received signals. However, this is merely an example of the transceiver 920, and thus, elements of the transceiver 920 are not limited to the RF transmitter and the RF receiver. Also, the transceiver 920 may receive signals via wireless channels and output the signals to the processor 910, and may transmit signals output from the processor 910, via wireless channels. The processor 910 may be provided in plural, and may execute a program stored in the memory 930 to perform at least one of a method of determining a BWP for a UE with a WUR or a signal transmitting and receiving method for the method according to the aforementioned embodiment of the disclosure.

According to some embodiment of the disclosure, the memory 930 may store programs and data necessary for operations of the BS. Also, the memory 930 may store control information or data which are included in a signal obtained by the BS. The memory 930 may be implemented as a storage medium including a ROM, a RAM, a hard disk, a CD-ROM, a DVD, or the like, or any combination thereof. Also, the BS may include a plurality of memories. According to some embodiment of the disclosure, the memory 930 may store the program for performing at least one of a method of determining a BWP for the UE with a WUR or a signal transmitting and receiving method for the method according to the embodiment of the disclosure.

The methods according to the embodiments of the disclosure as described in claims or specification may be implemented as hardware, software, or a combination of hardware and software.

When implemented as software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including a RAM or a flash memory, a ROM, electrically erasable programmable read only memory (EEPROM), a magnetic disc storage device, a CD-ROM, a DVD, another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible via any or a combination of communication networks such as Internet, an intranet, a local area network (LAN), a wide LAN (WLAN), a storage area network (SAN), or the like. Such a storage device may access, via an external port, a device performing the embodiments of the disclosure. Furthermore, a separate storage device on the communication network may access the device performing the embodiments of the disclosure.

In the afore-described embodiments of the disclosure, elements included in the disclosure are expressed in a singular or plural form according to the embodiments of the disclosure. However, the singular or plural form is appropriately selected for convenience of descriptions and the disclosure is not limited thereto. As such, an element expressed in a plural form may also be configured as a single element, and an element expressed in a singular form may also be configured as plural elements.

Specific embodiments of the disclosure are described in the descriptions of the disclosure, but it will be understood that various modifications may be made without departing the scope of the disclosure. For example, all or portions of some embodiments may be combined with all or portions of other one or more embodiments, and a combination thereof also corresponds to the disclosure. Thus, the scope of the disclosure is not limited to the embodiments described herein and should be defined by the appended claims and their equivalents.

Specific embodiments of the disclosure are described in the descriptions of the disclosure, but it will be understood that various modifications may be made without departing the scope of the disclosure. Thus, the scope of the disclosure is not limited to the embodiments described herein and should be defined by the appended claims and their equivalents.

The disclosure provides a method and apparatus for measuring a cell signal quality and selecting a cell for a UE with a WUR, thereby solving an excessive power consumption problem of the UE and achieving high energy efficiency in a wireless communication system.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to a base station, capability information indicating that a wake-up receiver (WUR) is supported at the UE;
receiving configuration information regarding a synchronization signal for the WUR or a wake-up signal (WUS) via master information block (MIB) or system information block (SIB), based on the capability information;
identifying a bandwidth part (BWP) indicated by the configuration information; and
receiving the synchronization signal for the WUR or the WUS on the identified BWP.

2. The method of claim 1,
wherein in case that an antenna port is shared between the WUR and a main radio of the UE, the configuration information indicates a common initial BWP, and
wherein in case that separate antenna ports are configured at the WUR and the main radio of the UE, the configuration information indicates a dedicated BWP for the WUR.

3. The method of claim 1,
wherein in case that an antenna port is shared between the WUR and a main radio of the UE, the main radio turns on after first switching delay time from a time at which the WUS is received,
wherein in case that separate antenna ports are configured at the WUR and the main radio of the UE, the main radio turns on after second switching delay time from a time at which the WUS is received, and
wherein the second switching delay time is different from the first switching delay time.

4. The method of claim 1, further comprising:
receiving a downlink signal on a common initial BWP via a main radio of the UE, after receiving the WUS.

5. The method of claim 1, further comprising:
identifying a BWP indicated by the WUS; and
receiving a downlink signal on the identified BWP via a main radio of the UE.

6. The method of claim 1, further comprising:
receiving a downlink signal on a last activated BWP before receiving the WUS via a main radio of the UE.

7. The method of claim 1, further comprising:
receiving information regarding one or more BWPs via a higher layer signaling; and
receiving a downlink signal on a BWP with a pre-configured index, among the one or more BWPs, via a main radio of the UE.

8. A method performed by a base station (BS) in a wireless communication system, the method comprising:
receiving, from a user equipment (UE), capability information indicating that a wake-up receiver (WUR) is supported at the UE;
transmitting configuration information regarding a synchronization signal for the WUR or a wake-up signal (WUS) via master information block (MIB) or system information block (SIB), based on the capability information; and
transmitting the synchronization signal for the WUR or the WUS on a bandwidth part (BWP) indicated by the configuration information.

9. The method of claim 8, further comprising transmitting a downlink signal for a main radio of the UE on a BWP indicated by the WUS.

10. The method of claim 8, further comprising:
transmitting a downlink signal for a main radio of the UE on a last activated BWP before transmitting the WUS.

11. A user equipment (UE) in a wireless communication system, the UE comprising:
at least one transceiver including a wake-up receiver (WUR) and a main radio; and
at least one processor coupled with the at least one transceiver and configured to:
transmit, to a base station, capability information indicating that the WUR is supported at the UE,
receive configuration information regarding a synchronization signal for the WUR or a wake-up signal (WUS) via master information block (MIB) or system information block (SIB), based on the capability information, and
identify a bandwidth part (BWP) indicated by the configuration information, and
receive the synchronization signal for the WUR or the WUS on the identified BWP.

12. The UE of claim 11,
wherein in case that an antenna port is shared between the WUR and the main radio of the UE, the configuration information indicates a common initial BWP, and
wherein in case that separate antenna ports are configured at the WUR and the main radio of the UE, the configuration information indicates a dedicated BWP for the WUR.

13. The UE of claim 11,
wherein in case that an antenna port is shared between the WUR and the main radio of the UE, the main radio turns on after first switching delay time from a time at which the WUS is received,
wherein in case that separate antenna ports are configured at the WUR and the main radio of the UE, the main radio turns on after second switching delay time from a time at which the WUS is received, and
wherein the second switching delay time is different from the first switching delay time.

14. The UE of claim 11, wherein the at least one processor is further configured to receive a downlink signal on a common initial BWP via the main radio of the UE, after receiving the WUS.

15. The UE of claim 11, wherein the at least one processor is further configured to:
identify a BWP indicated by the WUS, and
receive a downlink signal on the identified BWP via the main radio of the UE.

16. The UE of claim 11, wherein the at least one processor is further configured to receive a downlink signal on a last activated BWP before receiving the WUS via the main radio of the UE.

17. The UE of claim 11, wherein the at least one processor is further configured to:
receive information regarding one or more BWPs via a higher layer signaling; and
receive a downlink signal on a BWP with a pre-configured index, among the one or more BWPs, via the main radio of the UE.

18. A base station (BS) in a wireless communication system, the BS comprising:
a transceiver; and
at least one processor coupled with the transceiver and configured to:
receive, from a user equipment (UE), capability information indicating that a wake-up receiver (WUR) is supported at the UE,
transmit configuration information regarding a synchronization signal for the WUR or a wake-up signal (WUS) via master information block (MIB) or system information block (SIB), based on the capability information, and
transmit the synchronization signal for the WUR or the WUS on a bandwidth part (BWP) indicated by the configuration information.

19. The BS of claim 18, wherein the at least one processor is further configured to transmit a downlink signal for a main radio of the UE on a BWP indicated by the WUS.

20. The BS of claim 18, wherein the at least one processor is further configured to transmit a downlink signal for a main radio of the UE on a last activated BWP before transmitting the WUS.
